(19) United States
(12) Patent Application Publication
(10) Pub. No.: US 2007/0276845 A1
(43) Pub. Date: Nov. 29, 2007

(54) Locality indexes and method for indexing localities

(75) Inventor: Michael Geilich, Hanover, NH (US)

Correspondence Address: FLIESLER MEYER LLP, 650 CALIFORNIA STREET, 14TH FLOOR, SAN FRANCISCO, CA, 94108, US

(73) Assignee: TELE ATLAS NORTH AMERICA, INC., Lebanon, NH (US)

(21) Appl. No.: 11/433,104

(22) Filed: May 12, 2006

(51) Int. Cl. G06F 7/00; G06F 17/00

(52) U.S. Cl. 707/100

(57) ABSTRACT

Locality indexes are presented for use with electronic maps and databases. Each geographic feature in a geographic database is associated with locality names from various locality name sources. Context-sensitive tokenizing, normalizing, optimizing and matching of locality names eliminate duplicate and variant locality names, while preserving meaningfully different names. A locality names table includes the parsed representation of each locality name and other associated information, and a primary token for indexing is identified. A main source mask is created by allocating a bit for each locality name source used in the method. A separate source mask is stored for each geographic feature associated with a locality, a bit set for each source in which the locality can be found. Locality names associated with each geographic feature are indexed in a table of geographic features in order of prevalence for use in a given application.

### FIELD OF THE INVENTION

The present invention relates to indexes of localities for geographic databases, and more particularly, to data structures in geographic databases used for indexing locality names and associated geographic features contained in the localities.

### BACKGROUND OF THE INVENTION

In recent years, consumers have been provided with a variety of devices and systems to enable them to locate specific street addresses on a digital map. These devices and systems are in the form of in-vehicle navigation systems that enable drivers to navigate over streets and roads, portable hand-held devices such as personal digital assistants (“PDAs”), personal navigation devices and cell phones that can do the same, and Internet applications in which users can generate maps showing desired locations. The common aspect in all of these and other types of devices and systems is a geographic database of geographic features and software to access and manipulate the geographic database in response to user inputs. Essentially, in all of these devices and systems a user can enter a target location and the returned result will be the position of the target location. Typically, users will enter an address, the name of a business, such as a restaurant, a city center, or a destination landmark, such as the Golden Gate Bridge, and then be returned the location of the requested place, or feature. The location may be shown on a map display, or may be used to calculate and display driving directions to the location, or used in other ways.

Typically, applications use top-down searching methods that search for the locality in which a desired geographic feature is located, then search for the geographic feature within that locality. Examples of geographic features that can be found in a locality are addresses, landmarks and business locations. Applications also use bottom-up searching methods that search for all geographic features matching certain criteria, then choose the desired geographic feature from the list of localities in which matching geographic features are located.

Currently, either geographic databases are not supplied with locality indexes or have locality indexes that are of limited functionality when searching for geographic features in localities. A locality index may be used to select a locality name and associated information to display to a user. A locality is, for example, a city or town within a state (US), province (Canada), county, or other principal geographic feature. For geographic databases currently having locality indexes, the indexes are basically lists of locality names, ordered by name source, with duplication of names between sources. Locality names can be found in many locality name sources, such as administrative, postal and colloquial sources. The term “locality name” in this application is used to refer to any datum that can be used as a locality description. Apart from the sources listed above, postal codes themselves can be used as locality names. Also telephone exchange numbers indicate locality in some countries and can be used as locality names. In Germany, license plate prefixes indicate locality and can be used as locality names. The following is a discussion of geographic database prior art regardless of whether or not a geographic database is supplied with a locality index.

Currently, a geographic database populated with locality information from various locality name sources will contain duplicate entries for a locality if the locality name appears in multiple locality name sources. The device or system manufacturers or applications developers either do not merge the duplicate localities to a unique set of names or do an incomplete merge due to differences in the representation of the duplicates across locality sources, such as spelling, punctuation, abbreviation or other differences between the duplicates. Thus, when a user then queries a geographic database application for a locality, the user's device or system may list the same locality name multiple times if the locality name appears in multiple locality name sources. This is confusing to the user who must choose between identical or nearly identical names displayed to the user's system or device screen. A further problem exists in the list of locality names if the user is unable to differentiate between actual duplicate localities and disjoint localities having the same or slightly variant names. The problem of duplicate locality names from multiple locality name sources is exacerbated in some navigation devices that have limited memory. For example, some devices can hold only two locality names per geographic feature. For a geographic feature associated with more than two locality names, any selection of two of the locality names to use in the device may be suboptimal because localities that are duplicate but disjoint and localities having more prevalent locality names may be missing from the selection. A missing duplicate disjoint locality can lead a user to pick an incorrect locality due to its apparent uniqueness in a list. For geographic databases having locality indexes, failure to merge duplicate localities also creates locality indexes that are unwieldy in size, especially for limited-memory navigation devices.

Currently, for localities having the same or slightly variant names that share the exact same geographic features, duplicate name entries are not eliminated from prior art locality indexes. For localities having the same or slightly variant names that share at least one geographic feature, the name entries are not merged into a single entry in prior art locality indexes. A geographic database populated with locality information from various locality name sources may contain slightly variant names for a locality if at least two of the different sources have slightly variant names for the locality. For example, Ho-Ho-Kus, N.J., is known by slightly different names in different sources, such as Ho-Ho-Kus, Ho Ho Kus or Ho-Ho-Kus (Hohokus). For prior art locality indexes, failure to eliminate geographic database entries having slightly variant locality names creates locality indexes that are unwieldy in size, especially for limited-memory navigation devices, and confusion for users trying to distinguish between these slightly different locality names. For duplicately named yet disjoint localities, the prior art currently distinguishes between the localities by displaying additional information, such as the county in which the locality is located. For these localities, nearby, well-known or prevalent cities displayed as additional information with the localities would be more helpful to a user because city names and locations are more likely to be recognizable to the user than county names in the US.

FIG. 1 illustrates a diagram showing an example of locality definitions that are not treated consistently in common usage. Examples of locality definitions are “postal place” and “county subdivision.” In FIG. 1, in common usage, Allston is considered to be a part of Boston. Allston is a Postal Place and Boston is a County Subdivision. In FIG. 1, Postal Place: Allston is shown contained within County Subdivision: Boston. In contrast, Manhattan is considered to be a part of New York City, but Manhattan is a County Subdivision and New York City is a Postal Place as well as an Incorporated Place. In FIG. 1, County Subdivision: Manhattan is shown contained within Postal Place: New York City. Such contradictions illustrate the difference between common usage and formal locality definitions.

Further, in another example of locality definitions that are not treated consistently in common usage, certain geographic features in the state of New York are contained in the partially overlapping localities known in common usage as SoHo, Manhattan, and New York City. As mentioned above, New York City can be found in a Postal Place locality name source, and Manhattan can be found in an Incorporated Place locality name source. SoHo, on the other hand, cannot be found in a locality name source and is known colloquially. SoHo will be missing from a locality index based only on formal locality definitions.

Further, current geographic database locality indexes are not ordered by priority, or their importance for common usage. Further, for each geographical feature in a geographic database, localities associated with a geographic feature are not prioritized for the geographical feature. For a limited memory device that can store only a couple of locality names for each geographic feature, without prioritization of localities, an applications developer must choose a couple of locality names for a geographic feature associated with more than a couple of localities. Preferably, the highest priority localities associated with a geographic feature, or those localities that are the most well-known or most prevalent in common usage, would be displayed to a user's device. In presenting a list of localities to a user, the highest priority names associated with geographic features should be used since they will be the most recognizable.

Moreover, the most important name component, or primary token, of a locality name, such as “Hadley” in the name “South Hadley,” is not identified in some current geographic database locality indexes. When some currently commercially available navigation applications search for the city Hadley in Massachusetts, Hadley is retrieved, but South Hadley is not retrieved. To find South Hadley, the user has to begin with “S” and sort through many choices that begin with “South.”

A geographic database locality index is needed such that duplicate locality names and localities known by slightly variant names are merged, if and only if they represent the same locality, to eliminate confusion for a user who must otherwise choose between a list of identical or slightly variant names, especially for limited-memory devices. Such a locality index is also needed to reduce the size of the otherwise unwieldy index. While merging localities with duplicate and variant names, there is also a need to preserve meaningfully different locality names. A locality index is needed such that duplicate locality names that represent disjoint localities are distinguished. Otherwise, the user has no way to differentiate two different places with the same name. Further, a flexible locality index is needed such that formal locality definitions not treated consistently in common usage are accounted for, and such that the index is not based on these formal locality definitions. A locality index is needed that is ordered by locality priority for each geographical feature associated with multiple localities. Ordering by priority allows the most important names to be chosen to be included in limited memory applications and identifies the best name to present to the user. Finally, a locality index is needed such that the most important name component for a locality is part of the index to ensure that a search for the name component will return an expanded list of all relevant localities.

### SUMMARY OF THE INVENTION

Generally described, a locality index is provided for use with electronic maps and electronic databases, as well as a method and system for creating the index.

Locality names from various locality name sources are associated with the geographic features for each geographic feature in a geographic database. Context-sensitive tokenizing, normalizing, optimizing and matching of locality names allows for eliminating and merging of duplicate and variant locality names, while preserving meaningfully different names. Duplicate locality names are eliminated, if and only if they represent the same locality, to reduce confusion for a user who must otherwise choose between a list of identical or similar names. Geographic database entries for localities known by slightly variant names are merged into a single entry if the localities share at least one geographic feature in common. Disjoint localities having duplicate or slightly variant locality names are distinguished by adorning them with the name of a nearby locality if and only if they represent different localities, again to reduce confusion for a user who must otherwise choose between a list of identical names, or names that are distinguished in ways that are less meaningful to the user, for example, by adorning with county names whose locations are not generally known to users.

A locality name table is created and includes the full name of the locality, the locality's primary token for indexing and other associated information, such as an adornment, city center information and size of the locality. A main source mask is created by allocating a bit for each locality name source used in the method. For each geographic feature in a feature locality priority table, a separate source mask is stored for each locality associated with the geographic feature, a bit set for each source in which the locality can be found. In this table are links to the locality name table and a priority for each locality associated with a geographic feature. The feature locality table also includes links to the find feature table, which includes associated geographic feature information for each geographic feature.

The locality names for each geographic feature are indexed in order of priority. In the preferred embodiment, the highest priority locality associated with a geographic feature is that found in a preferred postal name source, then priority of the remaining localities is determined by the number of bits set in each locality source mask. In such an index, a first locality has a higher priority than second locality if the first locality is more well-known or prevalent in common usage.

Ordering by priority allows the most important names to be chosen to be included in limited memory applications and identifies the best name to present to the user in a bottom-up search. The unwieldy size of the locality index that would have contained duplicate and slightly variant locality names is thus reduced. Further, the locality index takes into account locality definitions that are not treated consistently in common usage because the index is not based on these formal locality definitions. Finally, the most important name component for a locality from the tokenizing step is part of the index to ensure that a search for the name component will return an expanded list of all relevant localities.

### BRIEF DESCRIPTION OF THE DRAWINGS

FIG. 1 illustrates a diagram showing an example of locality definitions that are not treated consistently in common usage.

FIG. 2 illustrates a diagram showing a hierarchy of United States administrative areas.

FIG. 3 illustrates an example of the need to differentiate between addresses with the same name, such as “Adams Street,” that are located in four different localities within a locality, such as “Boston, Mass.”

FIG. 4 illustrates an example of official localities and same-named neighborhoods such as “Brentwood, Calif.” that can be distinguished through the use of multiple types of locality name sources.

FIG. 5 illustrates an example of small villages that may be listed in official sources but that do not have clearly delineated boundaries, such as “Quechee, Vt.,” that are needed for inclusion in a comprehensive locality index.

FIG. 6 illustrates an example of neighborhoods, which are unofficial locality names, such as “Greenwich Village” in New York City, that are needed for inclusion in a comprehensive locality index.

FIG. 7 illustrates an example of villages located in a borough, such as “Forest Hills” in the borough of Queens in New York City, that are needed for inclusion in a comprehensive locality index.

FIGS. 8A and 8B show an embodiment of a process flowchart for linking localities to geographic features in a geographic database, tokenizing, normalizing, optimizing and matching locality names and creating an index of localities ordered by priority.

FIG. 9 illustrates an example of face voting used to determine a locality name for a street associated with an unknown locality name.

FIG. 10 shows two examples of locality name source masks for the United States and for Canada.

FIG. 11 shows an embodiment of an algorithm for reducing the locality name set through matching of locality names.

FIG. 12 shows an embodiment of an algorithm for determining the priority of locality names for a given geographical feature.

FIG. 13 shows an embodiment of locality index files including a Feature Locality Priority table, a Locality Name table and a Find Feature table.

FIG. 14 illustrates an example for which a navigation application can accommodate inconsistency when a nearby city is mistakenly specified.

FIG. 15 shows a block diagram of an exemplary system that can be used with embodiments.

### DETAILED DESCRIPTION

In order to create a better locality index, a thorough list of locality names must first be created by gathering names from a variety of locality name sources, administrative, postal and colloquial locality name sources, among others. Using locality names from any number and type of sources allows for a universal schema for international data. Without this feature only a fixed number of sources may be used, such as postal or administrative name sources, potentially missing important names and constraining the types of sources that may be used in different countries.

Although the language used in this description is specific to the United States, in embodiments, the same principles can be applied internationally with only nominal adjustments. Examples of foreign locality name source equivalents include the Ordnance Survey and Royal Mail in the United Kingdom, and Stats Can and Canada Post in Canada.

In embodiments, for a given set of locality name sources, a list of locality names is taken from each locality name source. In embodiments, the sources are those containing localities in one or more selected states, territories, provinces, or districts, for example. In the preferred embodiment, the sources are those containing localities in the United States. In the United States, for example, sources of locality names include, but are not limited to:

1. Federal Information Processing Standards 55 (FIPS55). This component of the United States Geological Survey (USGS) TIGER database is in the public domain (http://geonames.usgs.gov/fips55.html). FIPS55 is a standard source describing locality structure for administrative localities as defined by the government, for example, codes for named populated places, primary county divisions, and other locations of the United States, Puerto Rico and the outlying areas.

2. United States Postal Service (USPS) City/State file. This file is a component of the USPS ZIP+4 product. These city and state names are found at the address range or ZIP code level. Five-digit ZIP codes and four-digit extensions (ZIP+4) are treated as locality names in an index and point to the appropriate set of names in the USPS City State File. While there is generally only one preferred postal locality name for each location, the postal service also includes any number of permissible and non-permissible postal locality names for the same location. A “preferred” postal locality name is the name the USPS recommends for use in addressing mail. A “permissible” postal locality name is an alias name which the USPS has approved and allows for mail delivery. A “non-permissible” postal locality name is one the USPS does not allow for mail delivery. In embodiments, the locality index will include all of the preferred and permissible postal locality names for each geographic feature.

3. Geographic Names Information System (GNIS) provided by the United States Geological Survey (USGS). This is a public domain database of locality names in the United States, including the fifty states and the territories. GNIS lists city names, their center points, their populations, and similar information.

4. Points of Interests (POIs) for City Centers.

5. POIs for USPS Post Offices.

6. United States Census Bureau's Topologically Integrated Geographic Encoding and Referencing system (TIGER) Record Type C for entity “P” (Incorporated places in TIGER).

7. TIGER Record Type C for entity “M” (County Subdivisions in TIGER).

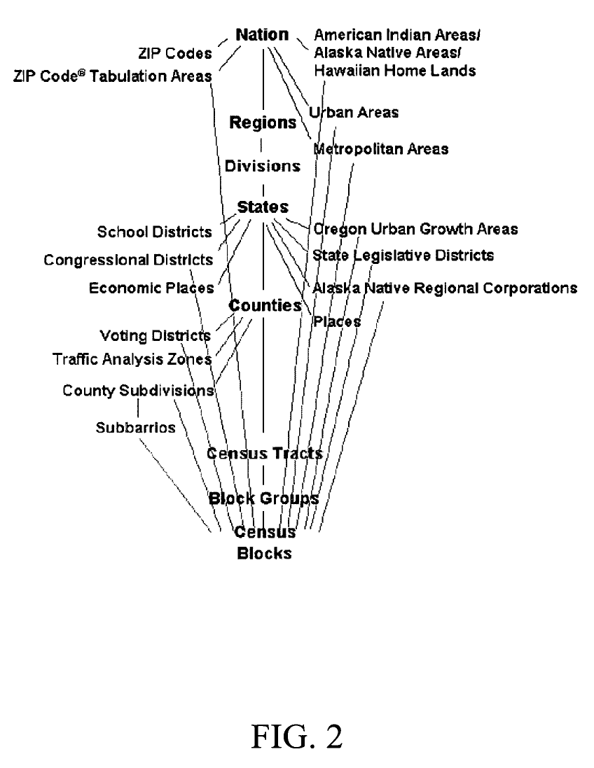

Locality names that are wholly contained within a state can be associated with the state for indexing purposes. Localities that are not wholly contained within a state, such as certain zip codes in the United States, can be multiply indexed under their containing states. FIG. 2 illustrates a diagram showing a hierarchy of United States administrative areas. These administrative areas are wholly contained within the groups shown centrally on the diagram as Nation, Regions, Divisions, States and Counties. This diagram shows that County subdivisions are contained within counties. Administrative Places, shown as “Places” in FIG. 2, are wholly contained within a state. Administrative Places may cross county and county subdivision borders. Metropolitan Areas, Urban Areas and even ZIP codes may even cross state borders, and thus are only wholly contained within the Nation, as shown in FIG. 2.

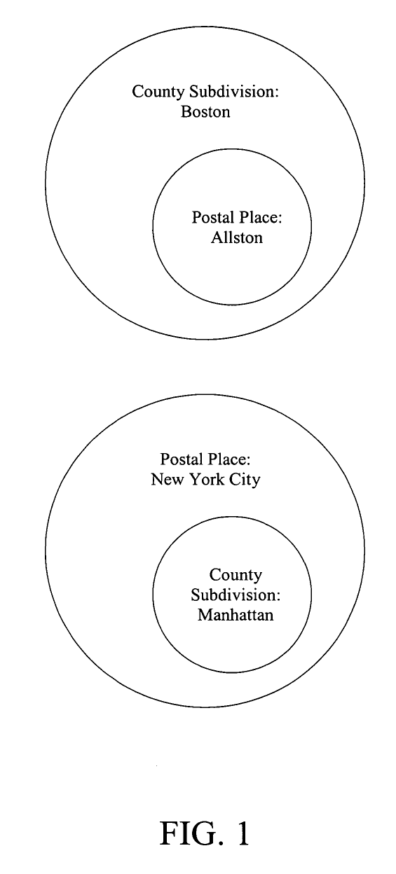

FIG. 1 illustrates an example diagram showing that localities in the United States can not be automatically modeled usefully for navigation applications using only a fixed set of rules for handling names from multiple locality sources. Postal places and county subdivisions are found in official sources. In FIG. 1, in Massachusetts, the Postal Place of Allston is wholly contained within the County Subdivision of Boston. In New York, however, the County Subdivision of Manhattan is wholly contained within the Postal Place of New York City. Thus, a County Subdivision locality name source can not necessarily be used to determine Postal Places within a particular county subdivision. Similarly, a Postal Place locality name source can not necessarily be used to determine a County Subdivision within a particular postal place. Common usage of locality names from different sources varies with geography. This variation must be accounted for when indexing locality names from multiple sources.

In embodiments, the following use case example, as used by a user of a software application or device that accesses the geographic database, illustrates the benefits of using locality names from multiple sources to build an index. If only one source of names is used, important names are omitted. Postal names, administrative names, and even colloquial names are all important.

Without postal name sources in Index:
Enter state-→Vermont
Enter city-→Quechee
City not found: Quechee

With postal name sources in Index:
Enter state-→Vermont
Enter city-→Quechee
Found-→
   Quechee

Without administrative name sources in Index:
Enter state-→New York
Enter city-→Manhattan
City not found: “Manhattan”

With administrative name sources in Index:
Enter state-→New York
Enter city-→Manhattan
Found: “Manhattan”

In embodiments, the following four use case examples show that another benefit of compiling locality names from multiple locality name sources is to differentiate between ambiguous street addresses within a locality. A city in the United States can have duplicate street addresses located in different parts of the city. This is especially true in large cities, such as Boston, Mass. As mentioned above, Boston can be found as a County Subdivision in the Administrative locality name source FIPS55. In embodiments, the first of these four use case examples shows a typical, non-problematic case of when a particular street address is unique within a city, there is no problem for navigation purposes, even if the city is large. An example of this is Newbury Street in Boston. This street name is ten blocks long and is not duplicated anywhere else in Boston:

With administrative name sources in Index:

| Enter state −> Massachusetts | |
|---|---|
| Enter City −> Boston | |
| Enter Street −> Newbury Street | // unique regardless of house |

number

At this point, the precise destination awaits more input from the user, such as a particular street number, the nearest intersection or the nearest block. When the input is supplied, a destination is pin-pointed on a map for the user:
Enter Street Number-→173
Found: “173 Newbury Street, Boston, Mass.”

In embodiments, the second of these four use case examples occurs when the street name is duplicated within a city, but the house number serves to make the destination unique. A long street that runs through several smaller towns within a large city is one such example. For example, Commonwealth Avenue runs through Boston, as well as smaller towns of Allston and Chestnut Hill within Boston. As mentioned above, Boston is a County Subdivision found in Administrative locality name source. Allston and Chestnut Hill are towns that can be found in Postal locality name sources under postal codes 02134 and 02467, respectively.

Without administrative name sources in Index:
Enter state-→Massachusetts
Enter city-→Boston
Enter street-→Commonwealth Avenue
Enter street number-→2000
Street number not found: “2000”

Because Boston is not a legitimate postal name for postal code 02467 according to the U.S. Postal Service, “2000 Commonwealth Ave, Chestnut Hill, Mass. 02467” is not found in the above example for Boston even though Chestnut Hill is a small town within Boston.

With both administrative and postal name sources in Index:
Enter state-→Massachusetts
Enter city-→Boston
Enter street-→Commonwealth Avenue

At this point, Commonwealth Avenue is found to run through Boston, Allston and Chestnut Hill. The precise destination awaits more input from the user, such as a particular street number, the nearest intersection or the nearest block. When the input is supplied, a destination is pin-pointed on a map for the user:
Enter street number-→2000
Found: “2000 Commonwealth Avenue, Chestnut Hill, Mass.”

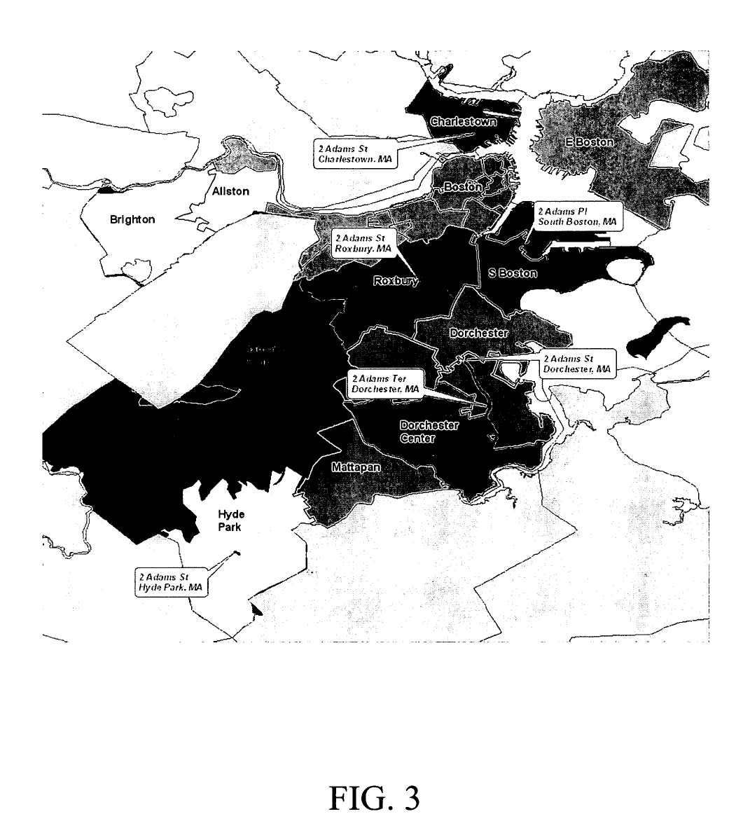

In embodiments, the third of these four use case examples as illustrated in FIG. 3 is similar to the second use case example, except that four different Adams Streets can be found in four different localities within Boston. FIG. 3 illustrates the need to differentiate between addresses with the same name, such as “Adams Street,” that are located in four different localities within a locality, such as Boston, Mass.:

Without postal name sources in Index:

Enter state −> Massachusetts
Enter city −> Boston
Enter street −> Adams Street
Please choose from −>

| Adams St., Boston | // the application finds four separate |
|---|---|
| Adams St., Boston | // Adams Streets in the city |
| Adams St., Boston | // of Boston and user is unable to |
| | differentiate |
| Adams St., Boston | // between these four choices |

With postal name sources in Index:

Enter state −> Massachusetts
Enter city −> Boston
Enter street −> Adams Street
Please choose from −>

Adams St., Charlestown
Adams St., Hyde Park
Adams St., Roxbury
Adams St., Dorchester

| | |
|---|---|
| Enter street number −> | // user continues by entering street number |

In this use case example, the application processes each user entry before requesting more information from the user. In other embodiments, for “With postal name sources in Index,” the user enters the city of Boston, the street of Adams Street, and a street number before the application processes these three entries. Assuming the street number is not duplicated in the small towns of Charlestown, Hyde Park, Roxbury and Dorchester, the street name and number will be found for one of these four towns and pin-pointed on a map to display to the user.

In embodiments, the fourth of these four use case examples shows that even street numbers, for example “2 Adams St.,” are duplicated on separate streets with the same name within a city. In this case, the only proper response is to present the user with a list of smaller towns in which the duplicates are located, in order to derive a unique destination. Thus, using the example from the third use case example above:

With administrative and postal names sources in Index:
Enter state-→Massachusetts
Enter city-→Boston
Enter street-→Adams Street
Enter street number-→2
Please choose from-→
   2 Adams Street, Charlestown
   2 Adams Street, Hyde Park
   2 Adams Street, Roxbury
   2 Adams Street, Dorchester

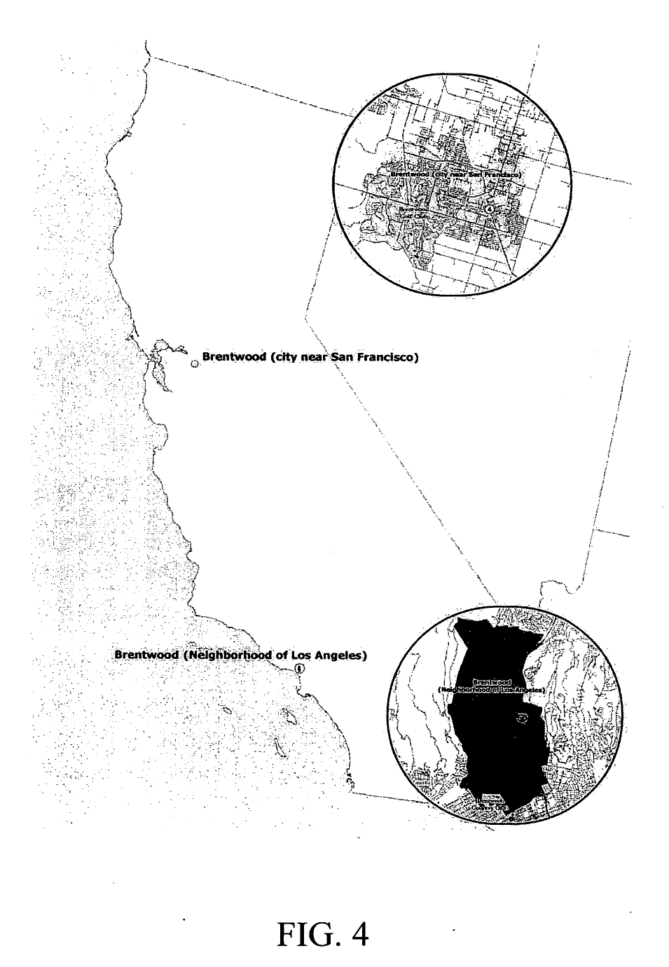

In embodiments, in another use case example as illustrated in FIG. 4, official localities and same-named neighborhoods such as “Brentwood, Calif.” can be distinguished through the use of multiple types of locality name sources. Brentwood, Calif. is both an official administrative place near San Francisco, and also a well-known, but unofficial neighborhood of Los Angeles that is a permissible, but non-preferred postal name. FIG. 4 shows both Brentwood localities in Calif. Both locations contain addresses that are prevalent for navigation purposes and a good navigation application will distinguish them for the user:
Enter state-→California
Enter city-→Brentwood
Please choose from-→
Brentwood (city near San Francisco)
   Brentwood (neighborhood of Los Angeles)

Using this same use case example, in other embodiments, if the user enters the state, city and street name before the application processes the user entries, the application can determine the correct Brentwood. For example:
Enter state-→California
Enter city-→Brentwood
Enter street name-→Concord Avenue
Enter street number-→767
Found: “767 Concord Avenue, Brentwood (city near San Francisco), Calif.”

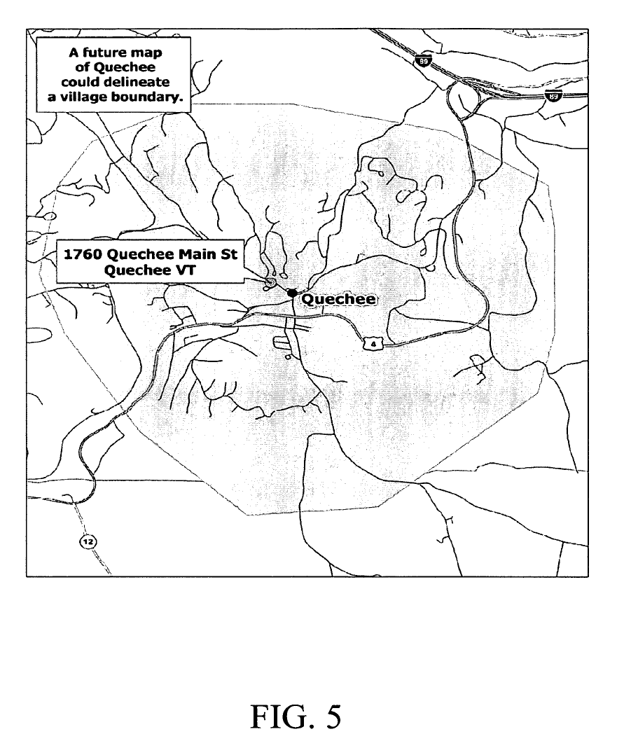

In embodiments, in a further use case example as illustrated in FIG. 5, small villages that may be listed in official sources but that do not have clearly delineated boundaries, such as “Quechee, Vt.,” are needed for inclusion in a comprehensive locality index. The village of Quechee, Vt. is a popular small town tourist destination. Simon Pierce Glassblowing can be found in the Yellow Pages as 1760 Quechee Main Street, Quechee, Vt. 05059. Quechee, however, is not an administrative locality, nor does the United States Postal Service recognize this address. ZIP code 05059 is a “Post Office Box only” ZIP code that contains very few street addresses. Thus, Quechee Main Street is not a recognized street within Quechee. The area surrounding the center of Quechee is known as White River Junction and Hartford. FIG. 5 illustrates a future map of Quechee with one possible delineated village boundary. A good navigation application needs to recognize addresses as they are published in Yellow Page directories, whether or not they are legitimate postal addresses or incorporated places:
Enter state-→Vermont
Enter city-→Quechee
Enter street-→Quechee Main Street
Enter number-→1760
Found: “1760 Quechee Main Street, White River Junction, Vt.”

Unfortunately, the Quechee locality name cannot be attached to the street address because the boundary of Quechee is not known. Instead, White River Junction is the designated locality for the street address. This choice is in accordance with Postal addresses. A navigation application can determine that it has found the desired location though use of the locality index, created as discussed below. Even though Quechee is not the locality for “1760 Quechee Main Street,” the locality index can expand the Quechee locality to locate the street in White River Junction, Vt. A navigation application can ask the user's confirmation when the matched locality differs from user input. Even though only one street has been found, it might be only a possible match, which the user of the navigation application could accept or decline. Map enhancements could make the right answer possible in the future with the addition of the boundary of Quechee. In that case, the name of the locality in which “1760 Quechee Main Street” is located will in fact be Quechee.

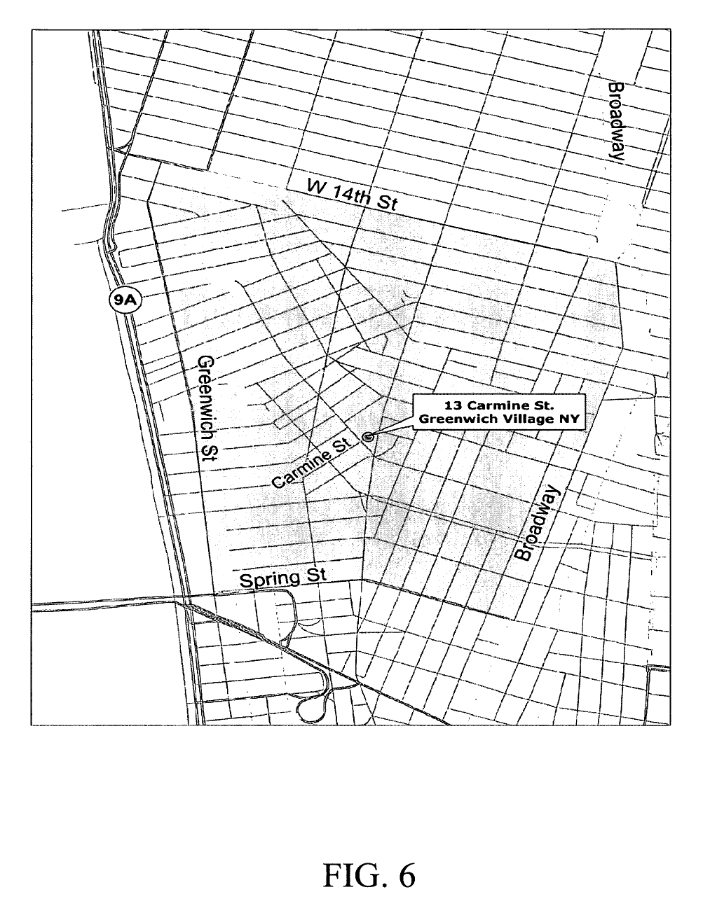

In embodiments, in a further use case example as illustrated in FIG. 6, neighborhoods, which are unofficial locality names, such as “Greenwich Village” in New York City, are needed for inclusion in a comprehensive locality index. There are various locality names in the United States that are important for navigation, yet not published in any administrative or postal source. One class of such names is famous neighborhoods. Examples include Greenwich Village and SoHo in New York City and Haight-Ashbury in San Francisco. These places are large enough to contain street segments, addresses, businesses and other points of interest. Good navigation applications will include the ability to locate well-known places and the street addresses within them, whether or not they are official administrative or postal names.

Without names from various sources:
Enter state-→New York
Enter city-→Greenwich Village
City not found: “Greenwich Village”

With names from various sources:

Enter state −> New York

| Enter city −> Greenwich Village | // Neither postal nor administrative |
|---|---|
| | name |

| | |
|---|---|
| Enter street −> | // user continues by entering street name |

In this use case example, using names from various sources, an enhanced map could include the boundary of Greenwich Village. FIG. 6 shows that Greenwich Village can be defined as the area of Manhattan bounded by Spring and 14^{th} Streets, between Greenwich St. and Broadway. Using a map with this information, the dialog would continue:

Enter street-→Carmine Street

Enter street number-→13

Found: “13 Carmine Street, Greenwich Village, N.Y.”

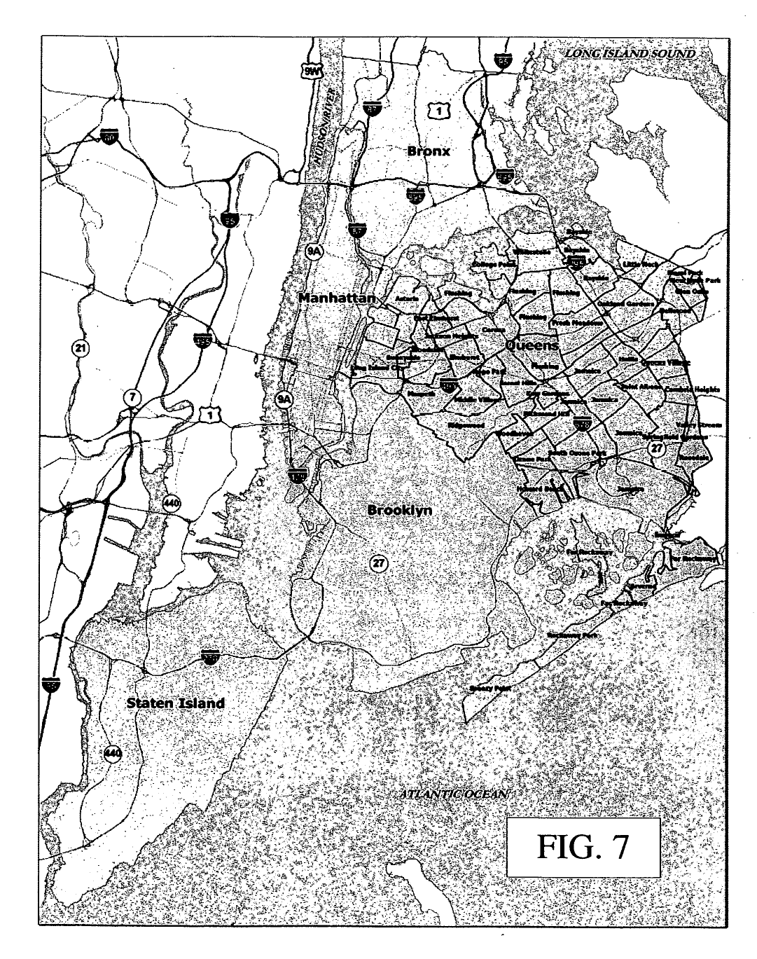

In embodiments, in a further use case example as illustrated in FIG. 7, villages located in a borough, such as “Forest Hills” in the borough of Queens in New York City, are needed for inclusion in a comprehensive locality index. Locality names from different sources can be used to determine which of the boroughs of New York City a street name can be located. The city of New York is composed of five boroughs. All but one of them, Queens, stands alone as a locality name. In Queens, however, tens of contained localities are defined. In looking for an address in Queens, the user does not need to know the locality within Queens in which the address is located. The locality index, discussed below, can determine which village contains the address, if the address in uniquely contained in only one village:
Enter state-→New York
Enter city-→Queens
Enter street-→70^{th} Rd.
Enter street number-→10700

Found: “10700 70^{th} Road, Forest Hills, N.Y.”

For this use case example, the locality index can also handle requests for the names of villages located in Queens:
Enter state-→New York
Enter city-→Forest Hills
Enter street-→70^{th} Rd.
Enter street number-→10700

Found: “10700 70^{th} Road, Forest Hills, N.Y.”

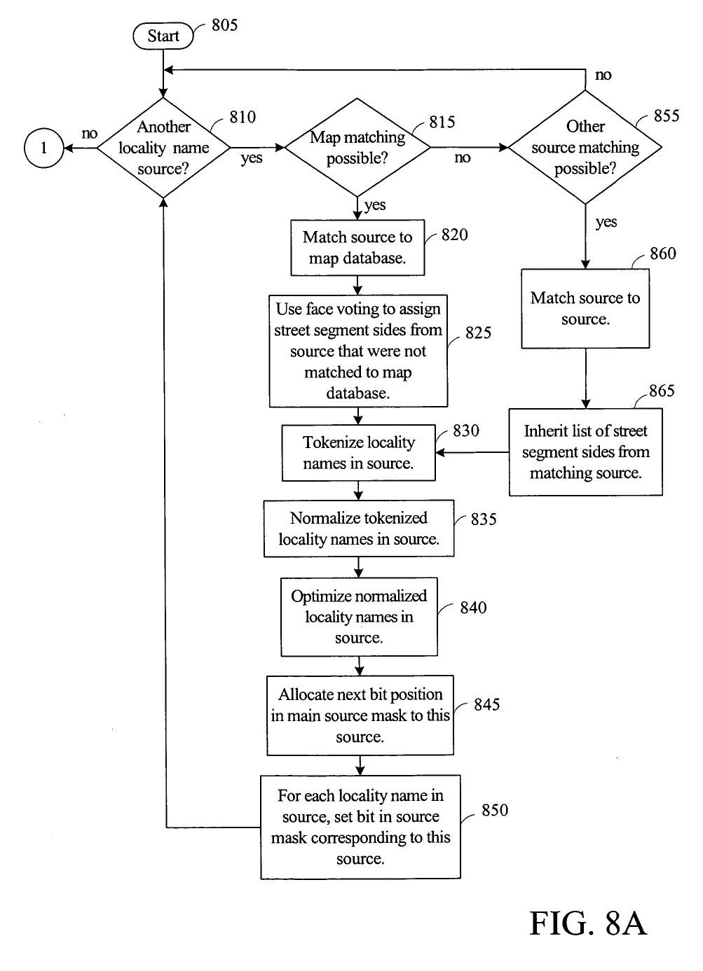

FIGS. 8A and 8B show an embodiment of a process flowchart for linking localities to geographic features in a geographic database, tokenizing, normalizing, optimizing and matching locality names and creating an index of localities ordered by priority. In embodiments, examples of geographic features that can be found in a locality include but are not limited to streets, street segments, street segment edges, block faces, landmarks, state parks, highways, ferry lines, bus routes, parcel centers, business locations and residential locations. A street segment is a portion of a street, an address range or a single address. A street segment edge is one street side of a street segment. A block face is one of four faces that constitute a city block.

For a given set of locality name sources from above and for a given proprietary geographic database, the process begins in step 805. If another locality name exists to process in step 810, in step 815, the process determines whether map matching is possible if the source contains geographic features that match those in the geographic database. If in step 815, map matching for the source is found to be possible, in step 820, map matching directly associates locality names from the locality name source with geographic features in the geographic database. Direct association can be performed automatically through conflation, or attribute matching, or manually by inspection. Direct association is typically used for locality name sources that share attributes with the geographic database. In the preferred embodiment, conflation can be used when the locality name source has spatial information attached to it indicating its location and extent on the earth. Direct association is made by overlaying localities from the locality name source spatially on the geographic database, assigning a locality to any geographic database features that occur within the boundary of that locality. Attribute matching is performed by matching common attributes between a source and the geographic database, which then allows a direct association to be made. Attributes that can be matched are those that can be represented by strings or numbers. Indirect association is typically used for the other sources.

In embodiments, in step 820 when the locality name sources shares attributes with the geographic database, a direct association to the geographic features in the geographic database is made by matching attributes in the source against the same attributes in the map or geographic database. For example, range-matching can be used to match address attributes between a locality source and the geographic database. Range-matching can be done using any source that has locality names associated with street detail, including TIGER, and the USPS City Place Names directory. County Subdivision (entity “M”) and Incorporated Place (entity “P”) codes are directly propagated from the matched TIGER geographic features onto the geographic features in the map or database of interest. Range-matching takes a street name, range of house numbers, and locality from TIGER and tries to match these items to a corresponding street segment in the proprietary geographic database of interest. In TIGER, each side of a street block not only has address range, it has tags representing the entity type P (incorporated place name) in that location, the entity type M (county subdivision name) in that location, a state code, a block code, a tract code, as well as Minor Civil Division (MCD). Ranges that match make it possible to transfer information from TIGER onto the geographic database. A range match can be either an exact match of street segments, street segments that touch or are exactly aligned, or street segments that partially overlap.

In step 820, where USPS City/State File is the locality name source, the deliverable address ranges from the source's USPS ZIP+4 catalog are geocoded against the map or database. In embodiments, ZIP codes from this source are treated as locality names themselves. ZIP codes from this source also point to the appropriate set of locality names in the City/State file. For each successful match, the five-digit ZIP code and one four-digit plus4 code from the ZIP+4 is treated as a locality name and are propagated onto the corresponding geographic feature.

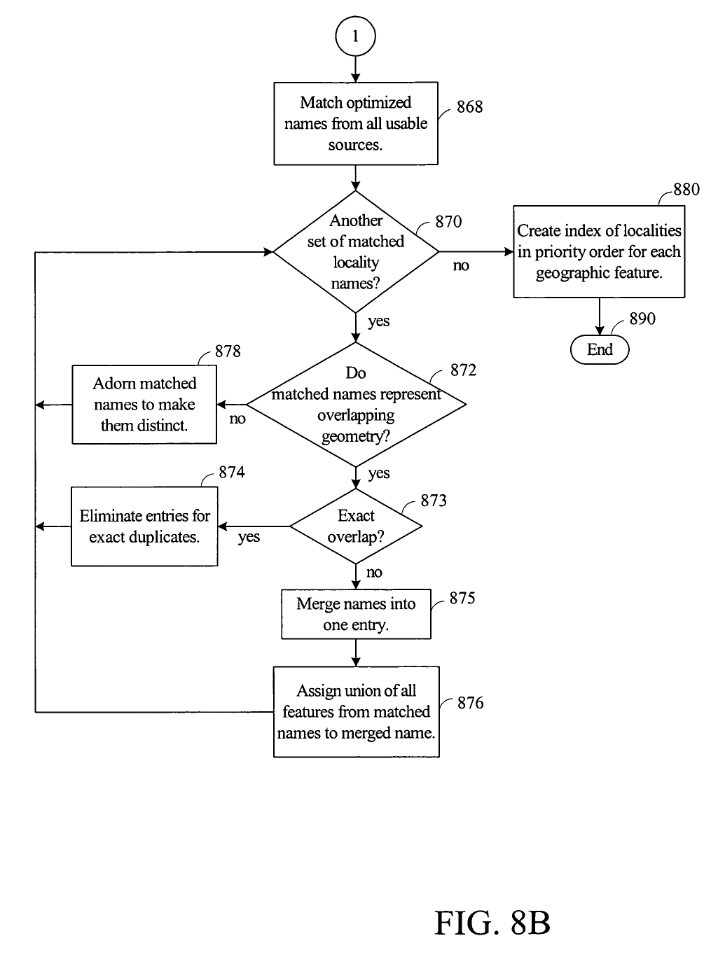

In step 825, for geographic features in a geographic database that were not matched to the locality name source, face voting is used to match the geographic features with other features in the geographic database, thereby inheriting locality assignments from the matched features. FIG. 9 illustrates an example of face voting used to determine a name for a city block face in the geographic database associated with an unknown locality name. In embodiments, holes or unmatched geographic features in the coverage for the TIGER name sources are eliminated by a process of “face voting.” For a city block that has a block face associated with an unknown city name, face voting determines a city name for the block face based on the city names corresponding to block faces that surround it, or block faces that connect the given block face to itself. FIG. 9 illustrates face voting for a city block, such that for a given block face, the block faces used in face voting are the two block faces adjacent to it and the one block face opposite from it. The FIG. 9 block faces can also be viewed as geographic features that are each one side of a street segment. The adjacent and opposite block faces are examined in embodiments, the dominant locality in which the unassigned face is located is determined by a majority vote of the other adjacent and opposite faces. This process propagates County Subdivision and Incorporated Place codes and their associated names onto any uncoded geographic features from the adjacent and opposite coded geographic features, which in embodiments are block faces.

For example, in FIG. 9, the north side of the one block street segment of Center Street is associated with an unknown city name because it is a geographic feature that was not associated with any locality in the locality name source. The other block faces, or the East side of the First Street one block street segment, the South side of the Main Street one block street segment and the West side of the Second Street one block street segment, however, were found to be associated with “Boston.” Because three of these three street segments for the block were associated with Boston, the face vote is three of three, and Center Street will also be associated with Boston. If two of these three street segments are associated with a particular city, the face vote is two of three, and Center Street will also be associated with the particular city. If the case of a tie, where the three street segments are each associated with a different city, then the face vote is one of three. Since there is no majority vote in this case, Center Street will be associated with the city of one of the adjacent streets closest to it, which in this case is either First Street or Second Street.

In embodiments, face voting can be used for other geographic features besides city block faces, such as street segment sides or road edges. In embodiments, face voting can be used for two or more other street segment sides besides the street segment associated with an unknown city name. In embodiments, face voting may also be used where two or more of the block faces are associated with unknown city names. In this case, a majority vote is taken from the remaining block faces, and either a majority vote or a tie is found and handled as discussed above. In embodiments, face voting may be used to associate the block faces with other locality names besides cities or towns. For example, locality names in the USPS City/State File are the five-digit ZIP code and one four-digit building code from the ZIP+4 file.

Other embodiments of face voting include a weighted vote or a linear length vote instead of a majority vote. In embodiments using a weighted vote, certain block faces adjacent to a block face not associated with a locality are given preference, or weighted more heavily in the voting process. A weighted vote could have any weighting component that measures the confidence of the adjacent block face assignments. For example, preference might be given to block faces corresponding to major streets or that are located in larger regions. Length of the block faces is another such weighting. In embodiments using a linear length vote, for a given block face not associated with a locality, for each known locality associated with block faces adjacent to the given block face, the total length of the block faces is taken to determine which locality associated with the adjacent block faces has block faces of the longest total linear length. This resulting locality is then assigned to the given block face not associated with a locality.

In FIG. 8A, if in step 815 map matching is not possible because the source does not share any attributes with the geographic database, in step 855, cross-source name matching is employed in embodiments. Cross-sourcing is indirect association of locality names in the source, or first source, to those of another source already directly associated with geographic features in the geographic database. In step 855, if cross-source name matching is possible because a second source already directly associated with geographic features in the geographic database is found with matching locality names to a first source, in step 860 the first source is matched to the second source. In step 865, each locality name in the first source inherits the associations to geographic features from the second source, and is thus indirectly associated to the particular geographic feature. In embodiments, examples of geographic features inherited are street segment sides, block faces, and ferry lines. In embodiments, the FIPS55 data is a useful name source for cross-source name matching. For example, the GNIS localities for Populated Places source is matched against the locality names in the FIPS55 source within a state and county. Where matches are made, the GNIS names inherit the associations to street segment sides from their matching FIPS55 names. From step 865, the process moves to step 830, as discussed below. If in step 855 cross-source matching is not possible for the source, the source is not usable in the process, and the process loops back to select another locality source in step 810.

Locality names taken from the various locality name sources are tokenized, normalized, optimized and/or matched, merged, or adorned to eliminate duplicate and variant locality names, in embodiments. In the preferred embodiment, all the steps of tokenizing, normalizing, optimizing, matching, and merging or adorning are performed. This process reduces the number of locality names for each locality that has two or more similar names, while also preserving locality names that are meaningfully different. These steps accommodate differences in name encoding between the various sources. One example of similar locality names from various sources is the city of Ho-Ho-Kus, N.J., which appears as follows in various locality name sources:
TIGER Record Type C: Ho-Ho-Kus Twnshp
USPS City State: HO HO KUS Township
POI Center of Settlement: HO-HO-KUS
FIPS55-3: Ho-Ho-Kus (Hohokus)

GNIS: Ho-Ho-Kus

From steps 825 and 865 in FIG. 8A, the process moves to step 830. In step 830, the first part of the name-matching process, tokenizing, or parsing, can break a locality name into as many as approximately ten tokens or components, in embodiments. Many techniques can be used to tokenize locality names. The purpose of this steps is to break out the significant component or portion of the locality name, or the name “body,” for indexing purposes. The other components, such as prefixes or suffixes will each be separate components. Locality names are then represented by tokens in an index, thereby allowing the applications developer to index on the significant portion of the name. For example, both Amherst and South Amherst will then be indexed under “A” if desired. Eliminating duplicates in embodiments will allow end users access to more names in limited memory applications and prevent user confusion from seeing the same name presented multiple times.

Tokenizing locality names from the first two locality name sources listed above for the Ho-Ho-Kus, N.J. example produces the following body and suffix tokens:
Body: Ho-Ho-Kus, Suffix: Twnshp
Body: HO HO KUS, Suffix: Township

Tokenization is helpful to isolate those components that define a unique name and by association, those tokens that can be ignored in the matching process. Most end users will desire that “Rutland” match “Rutland Township,” that is, that the term “Township” be treated as insignificant. At the same time, most end users will desire that “Boston” not match “South Boston,” that is, that the term “South” be treated as significant. Another reason for tokenization is to offer a software applications developer flexibility in presenting locality names to the end user because the significant portion of the name will be indexed. For example, by tokenizing “Hollywood” and “West Hollywood,” both will be presented as selection choices to a end user who enters a map search for “Hollywood.” This occurs because the “Body” token for both will be “Hollywood,” as West Hollywood will be tokenized as Body: Hollywood, Prefix: West, and Hollywood will be tokenized as Body: Hollywood.

In another embodiment, tokenization helps to determine the correct expansion of context-sensitive abbreviations. For example, a locality prefix token “St.” most likely refers to “Saint,” whereas a locality suffix token “St.” most likely refers to “State.”

The following are other types of tokens and examples of those tokens:
PreDirection—leading direction (“North” Adams)
PreType—leading type (“Lake” Isabella)
Prefix—leading, but not a direction or type (“Old” Orchard Beach))
PreName—non-type words before body (lake “of the” woods)
Body—main piece used for index purposes (Lake “Isabella”)
PostType—trailing type (Imperial “Beach”)
PostDirection—trailing direction token (Leisure Village “West”)
Suffix—trailing, but not a direction or type (Manchester “By The Sea”))
Division—numeric identifier specifying splits of the locality (Meredosia “1”)
Adornment—parenthetical supplemental information, such as a county name to clarify the whereabouts of a locality name (Middletown “(Bethlehem)”)

In step 835 of FIG. 8A, normalizing of tokens from the tokenizing step generally involves one or more of the following processes: expanding abbreviations, reducing or removing punctuation, using consistent case (upper or lower) and removing embedded spaces, in embodiments. In embodiments, standard abbreviations for directionals and for types are expanded. For example, directional abbreviation “N.” is expanded to “North.” For type abbreviations, for example, “Mt.” is expanded to “Mount” and “AFB” is expanded to “Air Force Base.” Given that names appearing in different sources may be represented differently, proper normalization of abbreviations is critical to the matching process. In embodiments, embedded spaces and punctuation are removed. In embodiments, capitalization can be normalized using either consistent upper case or lower case for the locality name tokens. Capitalization can also be normalized by capitalizing only the first letter of each token, in embodiments. Further, capitalization differences can be accommodated in the matching process instead of in the normalizing process, in embodiments. In the preferred embodiment, capitalization is normalized to consistent upper case. Using the Ho-Ho-Kus, N.J. example, normalizing the tokens produces the following results:
Body: HOHOKUS, Suffix: TOWNSHIP
Body: HOHOKUS, Suffix: TOWNSHIP

The following use case example illustrates the benefits of the tokenizing and normalizing features that can be stored in the locality index, the creation of which is discussed below. Without these features in the index, variant abbreviations appear as different city names. With these features in the index, abbreviations are put into a common form, allowing the applications developer to collapse the list into a single unambiguous entry. Although capitalization of tokens is normalized to consistent upper case to facilitate matching, tokens are typically presented to the user with only the first letter of each token capitalized.

Without tokenized and normalized locality names in the Index:
Enter city-→Randolph
Please choose from-→
   Randolph Hghts
   Randolph Heights
   Randolph Hts.

With tokenized and normalized locality names in the Index:
Enter city-→Randolph
You chose: Randolph Heights

The following use case example illustrates the benefits of tokenizing and normalizing directional tokens in locality names. By identifying directional tokens, locality names can be indexed by their body, rather than by directional. After directionals are normalized, an applications developer only needs to check for normalized tokens but not any abbreviations of those tokens.

Without tokenized and normalized locality names in the Index:
Enter city-→Boston
Found: Boston
Enter city-→South B
Please choose from-→
   South Bath
   South Barrister
   South Barnstable
   South Boston
Enter city-→S. Boston
City not found: “S. Boston”
Enter city-→South Boston
Found: “South Boston”

With tokenized and normalized locality names in the Index:
Enter city-→Boston
Please choose from-→
   Boston
   South Boston

In step 840 of FIG. 8A, optimizing for two or more similar locality names from the normalizing step generally associates each similar locality name with geographical features contained in the locality, in embodiments. Examples of geographic features include streets, street segments, landmarks, state parks, highways, business locations and residential locations. In the Ho-Ho-Kus, N.J. example, optimizing will find the same geographic features for HoHoKus and for HOHOKUS.

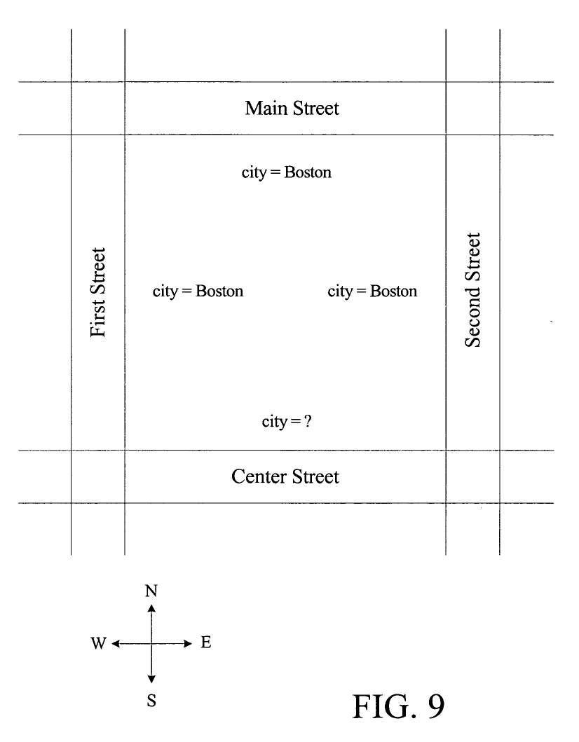

In step 845 of FIG. 8A, in a main source mask, the next bit in the source mask is allocated to the source. In embodiments, the mask is unique within a country. In other embodiments, the mask could be unique to any geographic area, such as a state or continent. FIG. 10 shows two examples of locality name source masks for the United States and for Canada. In embodiments, each bit position in the source mask represents a single locality name source. The mask can contain one or more administrative, postal or other locality name sources. The mask is unique to a country and does not imply priority of locality name sources. For each bit value in the column “Decimal Bit Value,” a locality name source in the column “Locality Name Source” is allocated to the bit value. For indexing purposes, the locality source mask enables the flexibility to define different sorts of locality names to best suit the end application. In embodiments, sources in the mask indicated as “Trump” can be used to give top priority to locality names that are found in these sources for indexing purposes. For each locality name in the source, an individual source mask is also created, showing the sources in which the locality name appears.

In step 850, the next bit position in the source mask for each locality name in the source is set to this source. Names that appear in multiple sources will have bits set in the mask for each source in which they appear. For example, the name “Boston” is simultaneously a county subdivision name, an administrative place and the preferred postal name for a number of ZIP codes. Names that do not appear in multiple sources will have only a single bit set in their mask corresponding to their source. The process loops back to step 810 to process the next locality name source if one exists.

If in step 810 of FIG. 8A there are no remaining locality sources left to process, the process moves to step 868 in FIG. 8B. In step 868, the optimized names from all usable sources are matched. The usable sources are those for which map matching was possible in step 815 and those sources for which other source matching was possible in step 855 in FIG. 8A. Matching concatenates the normalized tokens into full names and compares them to determine if they can be considered a match, in embodiments. In embodiments, normalization of locality name case or capitalization differences could be performed in this name matching step instead of the normalizing step above. In embodiments, case-insensitive matching logic could be used in this matching step. For each state in the United States, all locality names from the designated sources are matched in embodiments.

Many different algorithms are possible for name matching. Examples of name-matching techniques include context-sensitive matching, phonetic matching and Soundex. Context-sensitive matching is string matching of the names or matching of the spelling of names. This type of matching is performed with knowledge of which tokens are being matched that allows for special rules. For example, in the body token, a good context-sensitive matching algorithm can match “John F. Kennedy” and “John Fitzgerald Kennedy.” An excellent context-sensitive matching algorithm can match “MLK” and “Martin Luther King.” Phonetic matching, on the other hand, matches the sounds of words as opposed to the spelling of the words. For example, “fish” and “phish” match phonetically. For name matching in various languages, different phonetic matching algorithms can be used. Soundex is a phonetic algorithm for indexing names by their sound when pronounced in English. The basic aim is for names with the same pronunciation to be encoded to the same string so that matching can occur despite minor differences in spelling. More detailed information regarding phonetic algorithms can be found in application Ser. No. 11/377,764, filed Mar. 16, 2006, entitled “Geographic Feature Name Reduction Using Phonetic Algorithms” to Jesse Sheridan.

In embodiments, in order for two full names to match, the strings must match exactly. If full names do not match, in embodiments, a match of body tokens is attempted. Body tokens must match and direction and type tokens must also match for a successful token match. Thus, matching of the tokens may not start with one or both leading tokens, and one token must be a leading substring of the other. Thus, matching tokens must also ignore certain tokens. In embodiments, minor spelling variations can be allowed between two matching names. In embodiments, name matching is implemented fairly conservatively in order to prevent false matches. Thus:
“North Boston” does not match “South Boston”
“South Boston” does not match “Boston”
“Township of Rutland” does match “Rutland Township”

In step 870 of FIG. 8B, all sets of matched locality names found in step 868 are processed. Each set of matched locality names are localities having duplicate or slightly variant names. In step 870, if another set of matched locality names exists, the process determines if matched names represent overlapping geometry in step 872. In step 872, matched names represent overlapping geometry if the localities overlap or even if they are only adjacent to each other, as long as they share at least one geographic feature in common determined in the optimizing step 840.

If in step 872 of FIG. 8B, the matched names represent overlapping geometry, if in step 873, the overlapping geometry is exact, then in step 874, duplicate names except one are eliminated from the locality index entries in the geographic database. If all geographic features associated with one locality name are the same as those of another, these locality names are true duplicates and all but one are eliminated. Locality names are eliminated if and only if the names represent the same locality. This step eliminates duplicate localities and reduces the locality name set. For a locality index having many duplicate entries, this technique will greatly reduce the amount of indexing and space required by the index. In the Ho-Ho-Kus, N.J. example, the normalized tokens concatenated together for each name are both “HOHOKUS TOWNSHIP.” Because these two locality names will be determined to have all geographic features in common from the optimizing step, these locality names are true duplicates and one is eliminated. The process then loops back to step 870 to determine if another set of matched locality names exists.

If in step 873 of FIG. 8B the overlapping geometry is not exact, or a locality shares at least one but less than all geographic features with another locality, usually a locality with a slightly different name, these localities are deemed to be the same locality and are merged in step 875. For example, “Randolph” and “Randolph Center” in Vermont are two separate but overlapping towns. Because the two towns overlap, they share at least one geographic feature in common, are deemed to be the same locality and are merged.

In embodiments, merging of locality names only occurs when the overlapping localities have no non-overlapping features that can not be distinguished from each other. For example, if Randolph and Randolph Center both have a Main Street with no overlapping street numbers, the two towns can be merged. If both towns have a “2 Main Street” for example, however, the towns should not be merged.

The following use case example illustrates the benefit of eliminating all but one of the duplicate locality names from multiple sources that have overlapping geometry. Without this feature, a locality name is multiply listed in choices presented to the user.

Without eliminating duplicates:
Enter city-→Hanover
Please choose from-→
   Hanover (County subdivision)
   Hanover (Administrative place)
   Hanover (03755)

After eliminating duplicates:
Enter city-→Hanover
Found: “Hanover”

The following use case example also illustrates the benefit of merging localities having slightly different names. Without merging, the user may not know which slightly different name is the locality in which a desired destination is located. With merging, the user does not need to distinguish between names. For example, the localities “Randolph,” “Randolph Center” and “Randolph Township” overlap, and thus are merged into a common area, represented by the single name “Randolph.” Thus for a user search:

Without merging:
Enter city-→Randolph
Enter street-→Main Street
Please choose from-→
   Main Street, Randolph
   Main Street, Randolph Center
   Main Street, Randolph Township

With merging:
Enter city-→Randolph
Enter street-→Main Street
Found: “Main Street, Randolph”

In step 876 of FIG. 8B, a union of all features from the matched names are assigned to the merged name. For example, in FIPS55, the County Subdivision of Boston defines certain geography. The Administrative Place of Boston defines other geography that overlaps but is not necessarily the same. The postal place of Boston defines a third set of geography covering streets to which United States mail can be delivered. Creating a union of these different features forms a complete set of features that are associated with Boston. The union of the geographic features associated with each of these Boston-related names comprises a set of the geographic features including each of those sources. For example, if Adams St. is of interest to an end user, although Adams St. is not part of the postal place Boston, Adams St. will be found for the user because it is part of the County Subdivision of Boston due to the union of geographic features from matching locality names of various locality name sources. Thus, a list of unique locality names results, with bits set in a source mask corresponding to the sources in which each name is found, and a union of all geographic features to which each name applies. The process then loops back to step 870 to determine if another set of matched locality names exists.

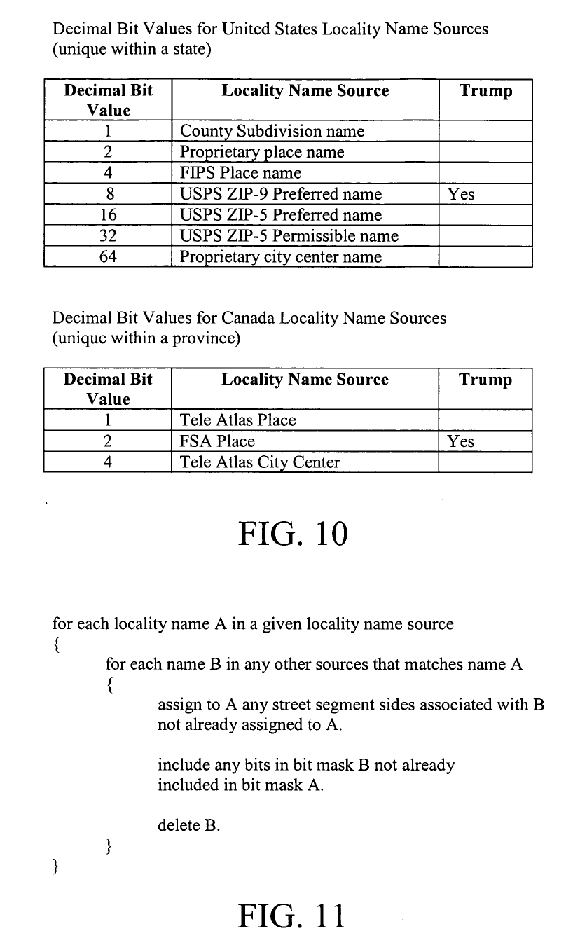

FIG. 11 shows an embodiment of an algorithm for reducing the locality name set through matching of locality names. For each locality name A in a locality name source, for each name B in any other sources that matches name A, assign to A any segment street sides associated with B not already assigned to A. This is step 876 of FIG. 8B above. Include any bits in source mask B not already included in the source mask A, and delete B.

In step 872 of FIG. 8B, if the matched names do not represent overlapping geometry, the matched names are adorned to make them distinct in step 878. The matched names that do not represent overlapping geometry are localities having duplicate or slightly variant names that are physically disjoint. In embodiments, these physically disjoint localities are cities that are located within a state in the United States. Many states have multiple cities with the same or slightly different names. Generally, such localities with duplicate names exist in different counties within a state. Thus, these duplicate names can be distinguished for a user by showing an adornment, for example the county name in which the locality is located. A locality's adornment is typically shown in parentheses or in quotes next to the locality name. County names or other border adornments, however, may not be recognizable to non-local users. Instead, the names of large, easily recognizable cities near each locality having duplicate names will provide better information to the user. Thus, in step 878, a separate city adornment is stored in the locality index for each of the names from step 872. More detailed information regarding creating this type of adornment can be found in application Ser. No. 11/345,877, filed Feb. 1, 2006, entitled “Method for Differentiating Duplicate or Similarly Named Disjoint Localities within a State or other Principle Geographic Unit of Interest” to Michael Geilich. The process then loops back to step 870 to determine if another set of matched locality names exists.

The following use case example shows adornments for disjoint localities having duplicate or slightly variant names:

Adorning with county names:
Enter state-→PA
Enter city-→Bethel
Please choose from-→
   Bethel (Berks)
   Bethel (Allegheny)
   Bethel (Lancaster)
   Bethel (Mercer)
   Bethel (Sullivan)
   Bethel (Wayne)

Adorning with large, nearby, easily recognizable city names:
Enter state-→PA
Enter city-→Bethel
Please choose from-→
   Bethel (Fredericksburg)
   Bethel (Pittsburgh)
   Bethel (Lancaster)
   Bethel (Youngstown)
   Bethel (Willamsport)
   Bethel (Scranton)

In this use case example, the application processes each user entry before requesting more information from the user. In other embodiments, for “Adorning with large, nearby, easily recognizable city names,” if the user enters the state, city and street name before the application processes these three user entries, a unique destination can be determined if the street address is found in only one of the choices. For example:

Adorning with large, nearby, easily recognizable city names:
Enter state-→PA
Enter city-→Bethel
Enter street name-→Main Street
Found: “Main Street, Bethel (Fredericksburg)”

If in step 870, another set of matched locality names does not exist, then in step 880 of FIG. 8B, the index is created. The index is first ordered by geographic feature. For each geographic feature, localities that contain the geographic feature are indexed in priority order. Locality names in the index are ordered by priority to allow applications developers to program selection of the most prevalent names for any geographic feature into the applications. This provides end users with the most prevalent names from which to select, for example, in limited memory environments. For a limited memory device that can store only a couple of locality names for each geographic feature, an applications developer can use the locality index to choose the highest priority localities to the user for a geographic feature associated with more than a couple of localities. Similarly, for bottom-up search applications, the application requests the address, or geographic feature, from the user and presents a list of localities from which the user chooses. In presenting the list of localities, the highest priority names associated with the address can be used.

In embodiments, priority order of the localities associated with a geographic feature is based on prevalence of each locality name in common usage for an intended application. In embodiments, prioritization based on common usage allows the locality names to be ordered differently for different users. In the example of overlapping localities such as “New York City,” “Manhattan” and “SoHo,” in common usage, a local user would know the area well would most likely use the more specific of the three localities, or “SoHo.” If an application is intended for this local user, the highest priority locality name would most likely be the one having the least number of sources in which the locality name can be found. Thus, the order of priority from highest to lowest would be “SoHo,” “Manhattan,” then “New York City.”

Using the same example of overlapping localities in New York City, in common usage, a non-local user who does not know the local area well, however, would most likely use the more well-known, easily recognizable locality. If an application is intended for this non-local user, the highest priority locality name would most likely be the one having the most number of sources in which the locality name can be found. Thus, the order of priority from highest to lowest would be “New York City,” “Manhattan,” then “SoHo.”

In embodiments, algorithms for determining priority order in an application can be applied differently to meet different common usages for a user. For example, for a local user navigating within a locality such as a large city, the user might want a priority of locality names based on common usage for a local user. While the same user navigates to the same large city from afar, however, the user might want a different priority based on common usage for a non-local user. Once the user reaches the large city and crosses the boundary into the city, however, the user might want the priority to change back to that of a local user.

Many different priority ordering schemes are possible. In the preferred embodiment, the highest priority locality associated with a geographic feature is that found in a preferred postal name source, then priority of the remaining localities is determined by the number of bits set in each locality source mask. In embodiments, a first locality has a higher priority than second locality if the first locality is more well-known or prevalent in common usage. In embodiments, the priority of a locality name is determined by the number of sources in which the name can be found. The locality name for a geographic feature with the highest priority is the locality name that can be found in the most number of sources, and thus, that has the most bits set in its source mask. Priority order of the locality names for a geographic feature is from highest to lowest.

In embodiments, an applications developer can also use the source mask to override this default priority scheme by preferring certain locality name sources over others. In other embodiments, priority is defined in terms of the largest physical locality size or largest locality population. In other embodiments, priority is defined as the largest number of geographic features, for example street segments, in a locality. Priority can also be defined in terms of the largest number of major geographic features located within the locality, as opposed to the number of geographic features located within the locality, in other embodiments. An example of a major geographic feature is an important highway. In embodiments, priority can be defined using the locality source masks to determine a preference of certain locality name sources over others. In embodiments, an applications developer can use locality names from locality sources indicated as “Trump” in FIG. 10 as the top-priority names.

In embodiments, in the case of locality priority ties, a primary sort is performed using one of the above schemes, and where necessary, by a secondary sort based on one of the above schemes. In the preferred embodiment, a primary sort is performed on the number of sources from highest to lowest in which each locality can be found. A secondary sort is based, for example, on the number of geographic features, or street segments, from highest to lowest contained in each locality.

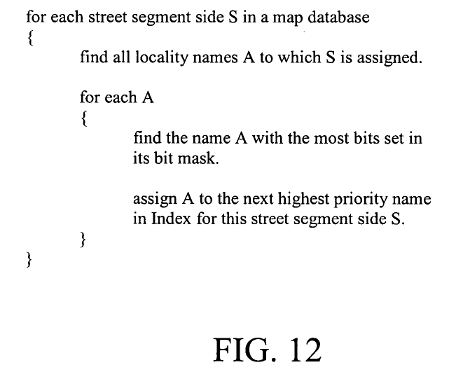

FIG. 12 shows an embodiment of an algorithm for determining the priority of locality names for a given geographical feature. For each street segment side S in a geographic database, find all locality names A to which S is assigned. For each A, find the name A with the most bits set in its source mask. Assign A to the next highest priority name in the Index for this street segment side S.

The process of FIG. 8B ends in step 890.

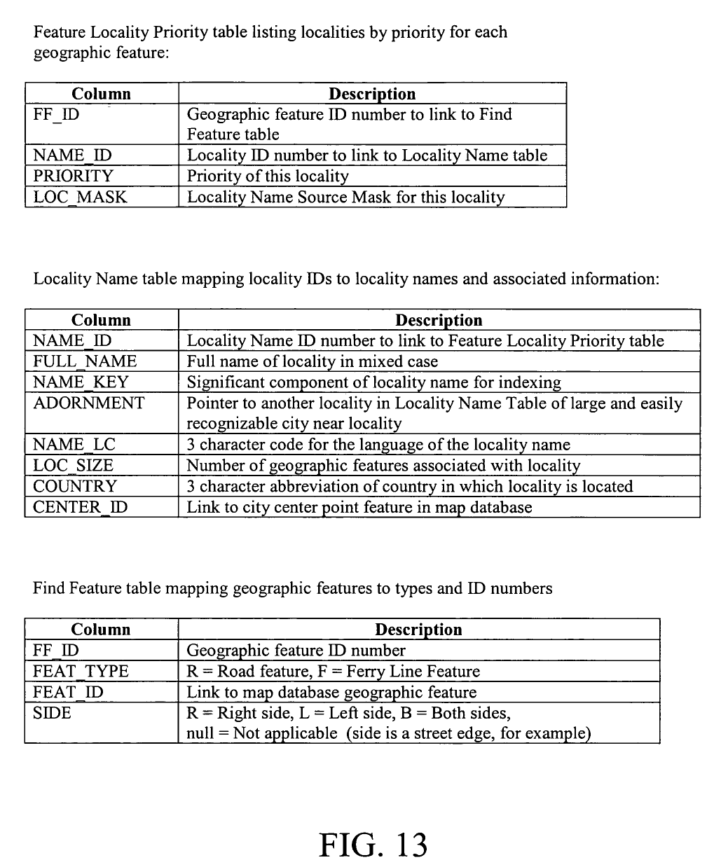

FIG. 13 shows an embodiment of locality index files including a Feature Locality Priority table, a Locality Name table and a Find Feature table. These tables are ultimately stored in a database. In embodiments, in the Feature Locality Priority table of FIG. 13, lists localities by priority for each geographic feature. In embodiments, each geographic feature in the table is associated with a feature ID number, FF_ID. The feature ID numbers can be sequential but do not necessarily have to be sequential. The feature ID numbers are also a link to the Find Feature table. In embodiments, each locality associated with each geographic feature in the table is also associated with a locality ID number, NAME_ID. The locality ID numbers can be sequential but do not necessarily have to be sequential. The PRIORITY field indicates the prevalence of the locality name associated with the geographic feature. As mentioned above, many priority schemes exist to prioritize the locality names associated with each geographic features. PRIORITY is a sequential number starting with “1” as the highest priority. The table also contains the locality name source mask for this locality, LOC_MASK, described above.

The variable format of the locality index allows any number of table entries to be included for each geographic feature in the Feature Locality Priority table. This is especially important in North America for postal names. While there is generally only one preferred postal locality name for each location, the postal service also includes any number of permissible postal locality names for the same location. The locality index includes all of the preferred and permissible postal names for each geographic feature.

In embodiments, the Locality Name table of FIG. 13 is linked to the Feature Locality Priority table through the locality ID numbers, NAME_ID. The table also contains the full name of the locality, FULL_NAME, using mixed case letters in embodiments. In embodiments, the full locality names as represented in FIPS55 are used for the final encoding of full locality names in this table. Other sources for representing full locality names may be used, however. The NAME_KEY field of the table is the significant component of the locality name for indexing purposes. In embodiments, NAME_KEY is found from tokenizing and normalizing the locality name above. This allows “Hollywood” and “West Hollywood” to both be indexed under “H,” for example, as the main body token for both is “Hollywood.” The ADORNMENT field is a pointer to another entry in the Locality Name Table containing the locality name of a large and easily recognizable location or city near the locality. In embodiments, ADORNMENT is stored in the table only when the locality is an ambiguous locality within a primary subdivision of a country, such as a state. In embodiments, the adornment is used for differentiating duplicate localities in a list on a user's device or system.

The NAME_LC field is a three character code for the language of the locality name. In embodiments, NAME_LC is set for each locality name to indicate the native language of the name to support multi-lingual countries. In embodiments, NAME_LC can be any number of characters. LOC_SIZE indicates a count of the number of geographic features associated with this locality name and can be used by applications developers to override the default PRIORITY scheme supplied in the Feature Locality Priority table. COUNTRY is a country code and is a three character abbreviation of the country in which the locality is located. In embodiments, COUNTRY can be a standard country code such as ISO 3166-1, which is part of the ISO 3166 standard first published by the International Organization for Standardization. In embodiments, COUNTRY can be any number of characters. CENTER_ID is a link to city center point features found elsewhere in the geographic database for this locality. In embodiments, these city center point features are the locality center point latitude and longitude coordinates, as well as a street segment corresponding to the city center. City centers provide a point within a locality to a user when a specific street address is not requested or cannot be found.

In embodiments, the Locality Name table of FIG. 13 could contain many other useful types of information about localities. For example, including phonemes in the Locality Name table would be useful for text-to-speech applications, where a phoneme is a set of speech sounds or sign elements that are cognitively equivalent. Other examples of different types of information that could be stored in the Locality Name table are a picture of a locality's city hall and the phone number of a locality's police department.

In embodiments, the Find Feature table of FIG. 13 contains information about each geographic feature. FF_ID is the feature ID number used to link geographic feature information to the Feature Locality Priority table. FEAT_TYPE is the type of geographic feature, such as “R” for road features and “F” for ferry line features. FEAT_ID is a link to information in the geographic database about the feature, such as street names and address ranges. FEAT_ID also provides indirect linkage to other content linked to the geographic database such as Points of Interest. SIDE is the side of the geographic feature, for example a street edge. SIDE includes “R” for right side, “L” for left side, “B” for both sides and “null” for “not applicable.”

In embodiments, the locality index is provided in multiple formats, including international formats, to enable easy integration with proprietary geographic databases. The locality index is provided to accommodate data from any country. While the format is generalized, the content is tailored to include specific locality sources and types appropriate in each country. A proprietary application provides the correct pronunciation for each locality name.

In embodiments, for locality index table usage, in a top-down implementation of finding an address, the locality is resolved first, and then the correct geographic feature is found within the locality. A navigation application will first perform name matching to find the desired locality name in the Locality Name table. Once the locality is found, the Feature Locality Priority table is searched using the NAME_ID of the chosen locality to determine the geographic features contained in that locality. The FF_IDs of those features are used as an index into the Find Feature table to retrieve information about those features needed to find a particular feature, such as street names and address ranges in the case of street segments, and then matching is performed to select the desired specific geographic feature. For example, [Enter City-→Boston]. “Boston” is matched to the names in the Locality Names Table, returning the NAME_ID for “Boston.” [Enter Street-→Adams]. The Feature Locality Priority Table is searched for a list of FF_IDs whose NAME_ID is the NAME_ID for “Boston.” The Find Feature Table is searched for the FEAT_ID that points to “Adams” in the geographic database. Subsequently, the desired house number can be requested from the user and the Find Feature Table is searched for the FEAT_ID that points to the address range containing the requested house number in the geographic database. The Find Feature Table could be searched for the FEAT_ID that points to the latitude and longitude point for this feature in the geographic database, in order to display to the user the location of the feature on a navigation application or device, for example. For improved performance, the locality index will often be pre-compiled to eliminate many of these indirect references.

In embodiments, for locality index usage, in a bottom-up implementation of finding addresses, a list of target geographic features is chosen first, then the correct feature is selected by resolving the desired locality from the list of all localities containing a feature by that name. A navigation application will first perform matching to find a list of geographic features in the Find Feature table. The corresponding FF_IDs from the Find Feature table are then used as indexes into the Feature Locality Priority table. The entries in the Priority table for these FF_IDs can then be scanned for a NAME_ID whose name in the Locality Name table matches the desired locality. If the applications developer wishes to present locality choices to the user, the application should consider the locality NAME_IDs in priority order, choosing the highest priority locality names that are unique for the FF_IDs under consideration. These names can then be presented to the user from which to choose. As in the top-down case, the locality index will often be pre-compiled to eliminate many of the indirect references between tables.

In embodiments, the locality index can be used to find named places such as points of interest and landmarks. Lists of such places are first associated with street segments from the proprietary geographic database. The application will then match the name of the desired point of interest or landmark to find the street segment. The application then uses the implementation of finding addresses above using the street segment in order to determine the correct locality.

In embodiments, the locality index can be used to find a city center. An application will name match the desired locality using FULL_NAME and NAME_KEY in the Locality Name table to find the correct entry in the table. Once the correct entry is found, the CENTER_ID field is used to find the corresponding proprietary locality center information in the geographic database, such as latitude and longitude coordinates or the street segment corresponding to the city center.

In embodiments, the locality index can be used to disambiguate locality with duplicate names, but distinct geography. An application will name match the desired locality using FULL_NAME and NAME_KEY in the Locality Name table to find the correct entry in the table. For example, if the locality is “Brentwood, Calif.,” two matches will be found as shown in FIG. 4. The ADORNMENT from the Locality Name table will thus be used for each Brentwood locality, for example adornments “Los Angeles” and “San Francisco.” These could be displayed to a user as “Brentwood (Los Angeles)” and “Brentwood (San Francisco)” from which the user can choose.

In embodiments, the locality index can be used to resolve ambiguity in address features. For example, for the “2 Adams Street” example in FIG. 3, the application will use the multiple locality names, ordered by PRIORITY for each feature, to distinguish between the four “2 Adams Street” addresses found within the locality of Boston, Mass. The application will first find address segments corresponding to the duplicate addresses in the geographic database, using the FEAT_ID field of the Find Feature table. The application will then find the corresponding FF_IDs in the Find Feature table. The FF_IDs are then used as indexes into the Feature Locality Priority table. Localities are retrieved in order from highest to lowest priority using PRIORITY until a unique NAME_ID is found for each FF_ID entry. The NAME_IDs are used as indexes into the Locality Name table to retrieve a unique locality name, FULL_NAME, for each duplicated address. In the example for “2 Adams Street,” unique locality names will be found in Charlestown, Hyde Park, Roxbury and Dorchester, all sub-localities of Boston, Mass.

In embodiments, the locality index can be used to search neighboring areas for a requested feature in a top-down application. In some cases a desired feature may not be found in a locality specified by a user and the navigation application will wish to expand the search to neighboring or larger containing localities. The application will first match the name of the desired locality in the Locality Name table, retrieving the corresponding NAME_ID. After determining that there are no FF_IDs corresponding to the requested feature in the Feature Locality Priority table with this locality NAME_ID, the application will find one or more FF_IDs in the Feature Locality Priority table that does contain this NAME_ID. The priority chain may be followed, either higher or lower priority, for these FF_IDs in the Feature Locality Priority table to retrieve other NAME_IDs corresponding to these FF_IDs. The Find Feature table can be consulted to determine if the requested address is within any of these other, related localities.

In embodiments, the following use case example illustrates the benefit of the prioritization feature of the locality index. Without prioritization, it is unclear to the applications developer how to use the most recognizable name when querying the user. In some places, postal names are the most common. In other areas, administrative names are well known. With the prioritization feature, the most common name can be chosen.

Without prioritization:
Enter street-→Broadway
Please choose from-→
   Broadway (Charlestown, Mass.)
   Broadway (Manhattan, N.Y.)

With prioritization:
Enter street-→Broadway
Please choose from-→
   Broadway (Boston, Mass.)
   Broadway (New York, N.Y.)

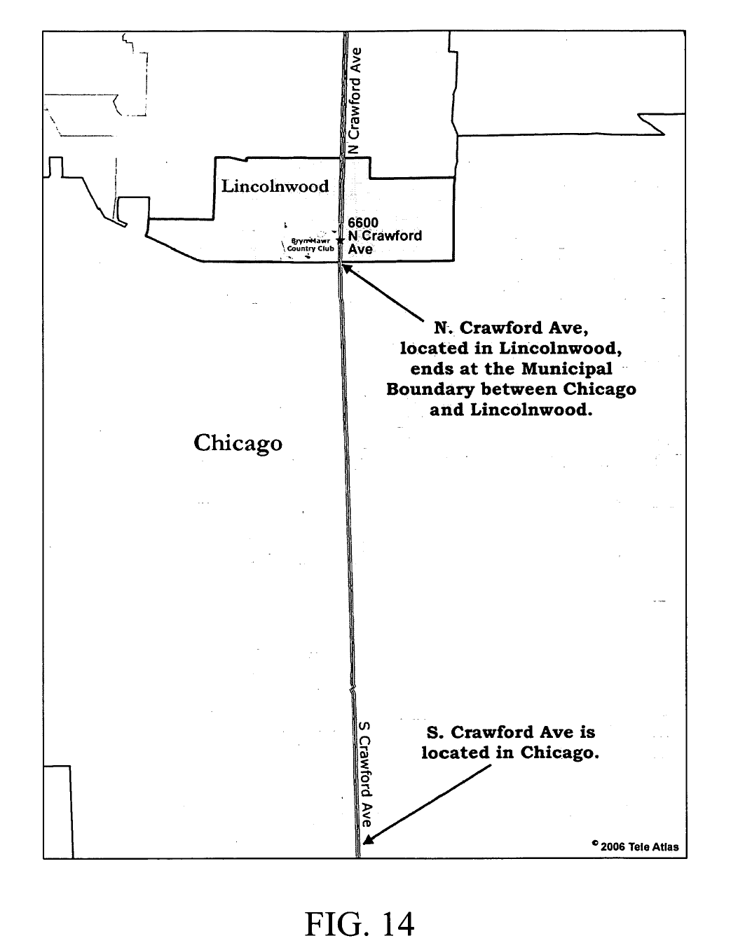

In embodiments, in a further use case example as illustrated in FIG. 14, a navigation application can accommodate inconsistency when a nearby city is mistakenly specified. Large cities like Chicago are generally surrounded by suburbs. The suburbs are separate, and have their own administrative structure. In particular, their locality names often differ. A user might not be aware of the suburban area, but only thinking of the large, central city. An example is found in the suburbs north of Chicago, as shown in FIG. 14. Suppose the user wants to locate “Bryn Mawr Country Club” in Lincolnwood, but only knows the area as Chicago. If the user knows that the street address is “6600 North Crawford Ave.,” the input might proceed as follows:
Enter state-→Illinois
Enter city-→Chicago
Enter street-→North Crawford Avenue

The navigation application would note an inconsistency here. The application will first search all FF_IDs in the Feature Locality Priority table where the NAME_ID points to Chicago. The application will note that “North Crawford Avenue” does not exist in Chicago. The application will search for all FF_IDs in the Feature Locality Priority table where the FF_ID points to “North Crawford Avenue.” The application will find “North Crawford Avenue” in the Chicago suburb of Lincolnwood. If the application had found “North Crawford Avenue” in several localities, the application would use the highest priority locality name for this FF_ID using PRIORITY in the Feature Locality Priority table. The application can note that “South Crawford Avenue” exists in Chicago. The application then requests the street number:
Enter street number-→6600
Found: “6600 North Crawford Avenue, Lincolnwood, Ill.”

In this example, if the correct street number was found in both places, the application could offer the user a choice: “6600 South Crawford Avenue, Chicago” or “6600 North Crawford Avenue, Lincolnwood.” Since street number “6600” is not found on “South Crawford Avenue” in Chicago, this address choice is not displayed to the user. Even though the street number “6600” found for “North Crawford Avenue” is located in Lincolnwood and not in Chicago, the application can assume that is the address the user intended to request.

In embodiments, in a further use case example, the application can provide for handling whether one of a user's inputs for the street or for the city is inconsistent and should be fixed. The address for Chandler Music Hall on its website is “71-73 Main Street, Randolph, Vt.” In the city of Randolph, Main Street is divided into “North Main Street” and a “South Main Street.” “Main Street” also exists in the nearby town of Randolph Center. For the end user, if the street is really Main Street, then the Hall must be in Randolph Center. If the Hall is in Randolph, then it is located on North Main Street or on South Main Street. The Hall is actually located in Randolph, at 71 North Main Street. If an end user was using the website address in a top-down application, the user would correctly be led from Randolph to North or South Main Street, but the application would ask the user for a decision because street number 71 exists on both streets. If the user was using the website address in a bottom-up application, the user would incorrectly be led from Main Street to Randolph Center. In embodiments, one way for a navigation application to handle this kind of situation is to present all the choices to the user:
Enter state-→Vermont
Enter city-→Randolph
Enter street-→Main Street
Enter street number-→71
Please choose from-→
   71 North Main Street, Randolph
   71 South Main Street, Randolph
   71 Main Street, Randolph Center

In embodiments, one or more steps of the present invention are carried out automatically. The automatic feature is implemented using appropriate software. The automatic feature creates a substantial increase in efficiency and speed with which locality indexes are created.

Embodiments of the present invention with modification can be applied to non-navigation applications and devices. For example, in a spatial Yellow Pages application, it is desirable to find all businesses of a certain type sorted by distance from a point. In embodiments, indexing localities for this type of application may use a priority scheme based on frequency of occurrence in a Yellow Pages directory.

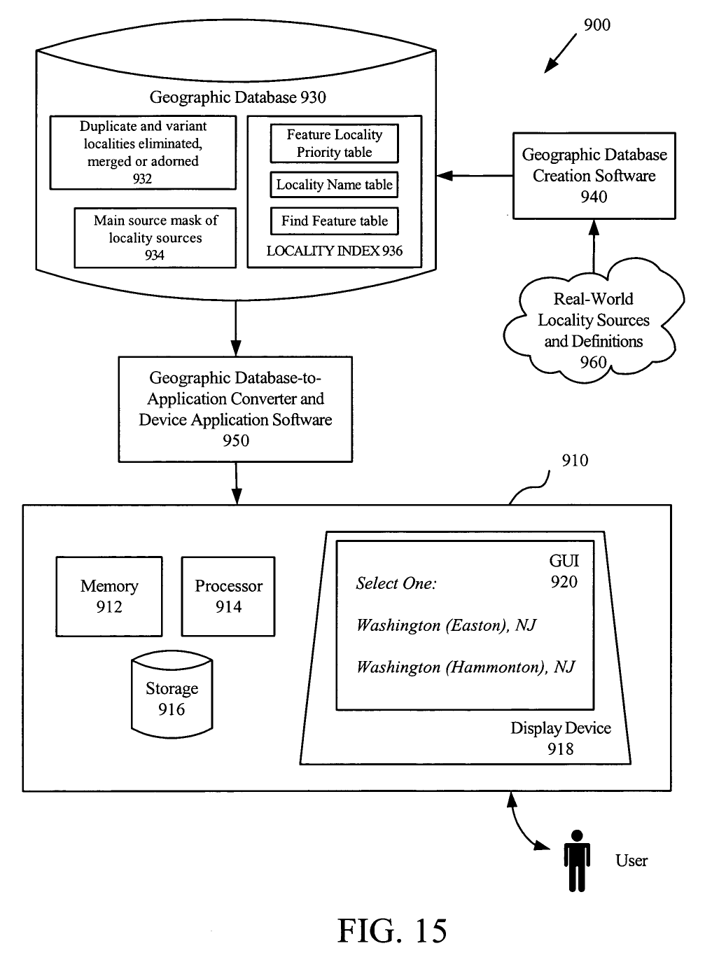

FIG. 15 shows a block diagram of an exemplary system 900 that can be used with embodiments of the present invention. Although this diagram depicts components as logically separate, such depiction is merely for illustrative purposes. It will be apparent to those skilled in the art that the components portrayed in this figure can be combined or divided into separate software, firmware and/or hardware components. Furthermore, it will also be apparent to those skilled in the art that such components, regardless of how they are combined or divided, can execute on the same computing device/system or can be distributed among different computing devices/systems connected by one or more networks or other suitable communication means.

As shown in FIG. 15, the system 900 typically includes a computing device 910 which may comprise one or more memories 912, one or more processors 914, and one or more storage devices or repositories 916 of some sort. The system 900 may further include a display device 918, including a graphical user interface or GUI 920 operating thereon by which the system can display maps and other information to a user. The user uses the computing device to request, for example, that a locality be displayed on a map or that driving directions be displayed as a route on a map and/or as text directions. The GUI 920 displays an example of a pair of duplicate localities for “Washington, N.J.,” and their adornments “Easton” and “Hammonton.” The user will select one of the duplicate localities to be displayed to GUI 920.

A geographic database 930 is shown as external storage to computing device or system 910, but the geographic database 930 in some instances may be the same storage as storage 916. In embodiments, locality name entries are merged for duplicate and variant localities 932 in geographic database 930. In embodiments, geographic database 930 contains a main source mask of locality sources 934. In embodiments, a locality index including Feature Locality Priority, Locality Name and Find Feature tables 936 is stored in the geographic database 930.

Proprietary geographic database creation software 940 can use real-world locality sources and definitions 960 to merge and/or adorn the duplicate and variant locality name entries 932, create the main source mask of locality sources 934 and create the locality index 936. Examples of real-world locality sources and definitions are described above in the discussion for FIG. 2. Information from the geographic database 930 is used by a geographic database-to-application converter and device application software 950, which is ultimately used by a user of the computing device 910. The geographic database-to-application converter and device application software 950 is shown remote to the user's computing device 910 but may also reside on the user's computing device 910.

For an example of a geographic database-to-application converter and device application software 950 as used by a user on the Internet, or on a navigation device, the user can select a locality to be displayed on a map. Alternatively, if the user requests driving directions, for example, the locality can be either the starting or ending locality.

In embodiments, the type of software application that queries the user can be a drill-down, either top-down or bottom-up, application. The drill down approach is useful in automobile-based navigation systems with limited memory. In embodiments useful for limited memory devices, the applications developer can include in the device only locality names that rank high in priority. A top-down application first requests the user to enter a principal geographic feature, for example a state or province. The application then requests the user enter a locality, for example a city or town, located in the principal geographic feature. The application then requests the user to enter the name of the street in the locality. Finally, the application requests the user to enter the street number. In most cases, the queries result in specification of an unambiguous geographic database feature for use by an application, for example displaying the locality to the user on GUI 920 of display device 918. A bottom-up application first requests the user to enter a house number and street name. The application then displays all the localities in which such an address can be found. Finally, the application requests the user to choose or enter the name of the desired locality. The bottom-up methodology also usually results in specification of an unambiguous geographic database feature which can then be used by the application.

In embodiments, the application software can use the geographic database index in a drill-down application, which allows the end user to enter a partial or full locality name, usually within a given state. In embodiments, the application presents names to the end user that match the user's input, and the user chooses the best option. Matching against the tokenized name bodies, the application can present both “Hollywood” and “West Hollywood” when any of the first letters of “Hollywood” are input by the end user.

In other embodiments, the software application is not a drill-down application and instead queries the user for street number and street, locality and principal geographic feature at one time. In most cases, the query results in specification of an unambiguous geographic database feature, and the process returns the location to the user. If the user enters a street name of “Main Street” and a locality of “Springfield,” a duplicate locality “Springfield” will be found if it also has a street by the name of “Main Street.” If duplicate localities exist for the geographical feature, then a list of localities and their adornments can be displayed to the user in order to ask the user to choose one, such as on GUI 920 of display device 918. For an example pair of duplicate localities for “Washington, N.J.,” the two localities can be adorned with the counties in which they are found or with names of nearby larger cities. “Easton, N.J.” and “Hammonton, N.J.,” respectively, are nearby large cities of the two duplicate localities. Thus, “Washington (Easton), N.J.,” and “Washington (Hammonton), N.J.,” are displayed to the GUI 920 of FIG. 15. In this example, the adornments are presented in parentheses but can be presented in other ways, such as by using commas to separate each duplicate locality from its respective adornment. The user selects one of the duplicate localities, and the locality on a map or driving directions are then displayed to the user.

Appropriate software coding can readily be prepared by skilled programmers based on the teachings of the present disclosure, as will be apparent to those skilled in the software art. Embodiments of the present invention may also be implemented by the preparation of application specific integrated circuits or by interconnecting an appropriate network of conventional component circuits, as will be readily apparent to those skilled in the art.

Embodiments of the present invention can include a computer program product which is a storage medium (media) having instructions stored thereon/in which can be used to program a computer to perform any of the processes of embodiments of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems, including molecular memory ICs, or any type of system or device suitable for storing instructions and/or data.

Stored on any one of the computer readable medium (media), embodiments of the present invention can include software for controlling both the hardware of the general purpose/specialized computer or microprocessor, and for enabling the computer or microprocessor to interact with a human user or other mechanism utilizing the results of embodiments of the present invention. Such software may include, but is not limited to, device drivers, operating systems, and user applications. Ultimately, such computer readable media further includes software for performing embodiments of the present invention, as described above.

Included in the programming or software of the general purpose/specialized computer or microprocessor are software modules for implementing the teachings of the present invention. Embodiments of the present invention may be conveniently implemented using a conventional general purpose or a specialized digital computer or microprocessor programmed according to the teachings of the present disclosure, as will be apparent to those skilled in the computer art.

The foregoing description of the present invention has been provided for the purposes of illustration and description. It is not intended to be exhaustive or to limit embodiments of the present invention to the precise forms disclosed. Many modifications and variations will be apparent to a practitioner skilled in the art. The embodiments were chosen and described in order to best explain the principles of the present invention and its practical application, thereby enabling others skilled in the art to understand the present invention for various embodiments and with various modifications that are suited to the particular use contemplated. It is intended that the scope of the present invention be defined by the following claims and their equivalents.

What is claimed is:

1. A geographic database locality index, storable on a storage medium, comprising:
a pointer to at least one geographic feature in a geographic database; and
a set of one or more locality names associated with the at least one geographic feature, wherein the one or more locality names are selected from one or more locality name sources and are ordered by priority based on prevalence of the one or more locality names in common usage for an intended application.

2. The index of claim 1, wherein geographic features comprise streets, street segments, street segment edges, block faces, landmarks, state parks, highways, parcel centers, ferry lines, bus routes, parcel centers, business locations and residential locations.

3. The index of claim 1, further comprising a main source mask created by allocating a bit for each of the one or more locality name sources used in the index.

4. The index of claim 3, further comprising a locality source mask for each locality associated with each geographic feature, wherein each bit in the locality source mask is set if the locality can be found in the source for which a corresponding bit was allocated in the main source mask.

5. The index of claim 1, wherein priority order can be applied differently to meet different common usages.

6. The index of claim 1, wherein common usage for an intended application comprises the least number of sources in which a locality name can be found if the application is intended for a local user.

7. The index of claim 1, wherein common usage for an intended application comprises the most number of sources in which a locality name can be found if the application is intended for a non-local user.

8. The index of claim 1, wherein priority of locality names for a geographic feature based on prevalence of each locality name in common usage for an intended application comprises a determination of the highest priority locality associated with a geographic feature to be the locality found in a preferred postal name source, then a determination of priority of the remaining localities associated with the geographic feature to be by the number of bits set in each locality source mask, wherein for the remaining localities, the larger the number of name sources in the source mask for the locality, the higher the priority of the locality.

9. The index of claim 1, wherein priority of locality names for a geographic feature based on prevalence of each locality name in common usage for an intended application comprises a determination of a number of locality name sources in which the locality can be found from the source mask associated with the locality, wherein the larger the number of name sources in the source mask for the locality, the higher the priority of the locality.

10. The index of claim 1, wherein an alternate priority of locality names for a geographic feature comprises being based on a determination of one of:
a number of geographic features in each locality, wherein the larger the number of geographic sources in the locality, the higher the priority of the locality;
a physical size of each locality, wherein the larger the physical size of the locality, the higher the priority of the locality; and
a population size of each locality, wherein the larger the size of the population of the locality, the higher the priority of the locality.

11. The index of claim 1, wherein an alternate priority of locality names for a geographic feature comprises being based on a determination of a preference of a certain locality name source over others using the locality source masks, wherein localities having a bit set in their locality source masks for the certain locality have a higher priority than localities that do not.

12. The index of claim 3, wherein the main source mask further comprises a trump source, wherein an alternate priority of locality names for a geographic feature comprises being based on the trump source, wherein localities having a bit set in their locality source masks for the trump source have a higher priority than localities that do not.

13. The index of claim 1, wherein if a determination of priority of locality names for a geographic feature results in a tie between localities, priority of the tying localities comprises being based on a determination of one of:
a number of geographic features in each tying locality, wherein the larger the number of geographic sources in the tying locality, the higher the priority of the tying locality;
a physical size of each tying locality, wherein the larger the physical size of the tying locality, the higher the priority of the tying locality;
a population size of each tying locality, wherein the larger the size of the population of the tying locality, the higher the priority of the tying locality; and
a preference of a certain locality name source over others using the locality source masks, wherein tying localities having a bit set in their locality source masks for the certain locality have a higher priority than tying localities that do not.

14. The index of claim 1, wherein association of a locality name from the one or more locality names to the at least one geographic feature comprises direct or indirect association.

15. The index of claim 14, wherein direct association comprises for a particular locality name source associated with geographic features in general, matching any geographic features associated with the locality name to the at least one geographic feature in the geographic database using at least one common attribute between the locality name source and the geographic features in the geographic database.

16. The index of claim 15, further comprising a face vote taken of matched geographic features on a map adjacent to an unmatched geographic feature in the geographic database to assign a locality to the unmatched geographic feature.

17. The index of claim 16, wherein a face vote comprises one of a majority vote, a weighted vote and a linear length vote.

18. The index of claim 14, wherein indirect association comprises for a first locality name source that is not associated with geographic features in general, cross-source locality name matching with a second locality name source that is associated with geographic features is used such that each locality name in the first source inherits the associations to geographic features from the second source.

19. The index of claim 1, further comprising a main token of the locality name, wherein the main token is determined by one or more of tokenizing, normalizing, and optimizing the locality names, as well as matching the locality name with any duplicate or similar locality names.

20. The index of claim 19, wherein tokenizing comprises breaking the locality names into tokens, or components.

21. The index of claim 19, wherein the main token comprises the main body or main component suitable for indexing.

22. The index of claim 20, wherein tokens besides the main token comprise one or more of a leading direction token, a leading type token, a prename or non-type information preceding the body, a prefix, a trailing type, a trailing direction, a suffix, a numeric identifier specifying splits of the locality, and an adornment or nearby, easily recognizable city name.

23. The index of claim 19, wherein normalizing comprises one or more of expanding abbreviations, reducing punctuation, removing embedded spaces and normalizing capitalization.

24. The index of claim 19, wherein optimizing comprises associating the locality name with geographic features contained in the locality.

25. The index of claim 19, wherein matching the locality name with any duplicate or slightly variant locality names comprises concatenating locality name tokens and comparing tokens for the locality name with the tokens for any duplicate or similar locality names to determine matches.

26. The index of claim 19, wherein matching the locality name with any duplicate or slightly variant locality names comprises matching the names based on their phonetic representation or by other means.

27. The index of claim 26, wherein matching further comprises comparing geographic features from the optimizing step for the locality name and any duplicate or slightly variant locality names to determine if these localities overlap or are adjacent.

28. The index of claim 27, wherein if all of the geographic features match for the locality name and any duplicate or slightly variant locality names these locality names represent the same locality, and duplicate locality names except one locality name are eliminated from the index.

29. The index of claim 27, wherein if one or more but not all of the geographic features match for the locality and any duplicate or similar localities, these locality names are deemed to represent the same locality and are merged into one locality name in the index.

30. The index of claim 29, wherein a union of all geographic features from localities that overlap or are adjacent are associated with the merged locality name.

31. The index of claim 27, further comprising adornments of nearby, well-known cities that are created and stored in the index for disjoint localities resulting if none of the geographic features match for the locality and any duplicate or similar localities.

32. The index of claim 1, further comprising one or more of geographic feature identification numbers, locality identification numbers, locality city center latitude and longitude points, locality adornments, full names of localities and size of localities.

33. The index of claim 1, wherein the index is created automatically.

34. A method for indexing a locality, comprising the steps of:
receiving a selection of one or more geographic features from a geographic database;
determining a set of one or more locality names from a set of one or more locality name sources;
associating the locality names with the geographic features of the geographic database;
prioritizing for each geographic feature the associated locality names in order of prevalence in common usage for an intended application; and
ordering the locality names associated with each geographic feature by priority.

35. A system that includes functionality for enabling a user to access localities and geographic features within the localities, comprising:
a geographic database index having at least one geographic feature in a geographic database and a set of one or more locality names associated with the at least one geographic feature, wherein the one or more locality names are selected from one or more locality name sources and are ordered by priority based on prevalence of the locality name in common usage for an intended application; and
an applications program that uses the geographic database index in combination with displaying locality and geographic feature information to a user and with receiving input from a user.

36. The system of claim 35, wherein the display of locality and geographic feature information comprises one or more of textual display of locality and geographic feature information to a user, display of the location of geographic features on a map to the user and display of routing information on a map to the user.

37. The system of claim 35, wherein the system comprises an Internet-based system.

38. The system of claim 35, wherein the system comprises an in-vehicle navigation system.

39. A portable hand-held device that includes functionality for enabling a user to access localities and geographic features within the localities, comprising:
a geographic database index having at least one geographic feature in a geographic database and a set of one or more locality names associated with the at least one geographic feature, wherein the one or more locality names are selected from one or more locality name sources and are ordered by priority based on prevalence of the locality name in common usage for an intended application; and
an applications program that uses the geographic database index in combination with displaying locality and geographic feature information to a user and with receiving input from a user.

40. The portable hand-held device of claim 39, wherein the display of locality and geographic feature information comprises one or more of textual display of locality and geographic feature information to a user, display of the location of geographic features on a map to the user and display of routing information on a map to the user.

41. The portable hand-held device of claim 39, wherein the portable hand-held device comprises a personal digital assistant (PDA).

42. The portable hand-held device of claim 39, wherein the portable hand-held device comprises a personal navigation system.

43. The portable hand-held device of claim 39, wherein the portable hand-held device comprises a cell phone.

44. A Geographical Information Systems (GIS) based applications program that includes functionality for enabling a user to access localities and geographic features within the localities, comprising:
a geographic database index having at least one geographic feature in a geographic database and a set of one or more locality names associated with the at least one geographic feature, wherein the one or more locality names are selected from one or more locality name sources and are ordered by priority based on prevalence of the locality name in common usage for an intended application.

45. A machine-readable medium, including operations stored thereon that, when processed by one or more processors, causes a system to perform the steps of:
receiving a selection of geographic features from a geographic database;
determining a set of one or more locality names from a set of one or more locality name sources;
associating the locality names with the geographic features from the geographic database;
prioritizing for each geographic feature the associated locality names in order of prevalence in common usage for an intended application; and
ordering the locality names associated with each geographic feature by priority.
